(19) United States
(12) Patent Application Publication
(10) Pub. No.: US 2017/0301002 A1
(43) Pub. Date: Oct. 19, 2017

(54) VECTOR-BASED DATA STORAGE METHODS AND APPARATUS

(71) Applicant: Wal-Mart Stores, Inc., Bentonville, AR (US)

(72) Inventors: Bruce W. Wilkinson, Rogers, AR (US); Todd D. Mattingly, Bentonville, AR (US); Michael D. Atchley, Springdale, AR (US)

(21) Appl. No.: 15/488,107

(22) Filed: Apr. 14, 2017

Related U.S. Application Data
(60) Provisional application No. 62/323,026, filed on Apr. 15, 2016.
(60) Provisional application No. 62/348,444, filed on Jun. 10, 2016.
(60) Provisional application No. 62/436,842, filed on Dec. 20, 2016.
(60) Provisional application No. 62/485,045, filed on Apr. 13, 2017.
(60) Provisional application No. 62/406,487, filed on Oct. 11, 2016.
(60) Provisional application No. 62/350,312, filed on Jun. 15, 2016.
(60) Provisional application No. 62/360,629, filed on Jul. 11, 2016.
(60) Provisional application No. 62/367,299, filed on Jul. 27, 2016.
(60) Provisional application No. 62/358,287, filed on Jul. 5, 2016.

(51) Int. Cl. G06Q 30/06; G06Q 10/08

(52) U.S. Cl. CPC G06Q 30/0631; G06Q 10/083

(57) ABSTRACT

A control circuit selects at least one particular one of a plurality of products to present to a particular customer as a candidate for automatic periodic shipping as a function, at least in part, of partiality vectors for that particular customer and vectorized characterizations for each of a plurality of products. These vectorized characterizations can each indicate a measure regarding an extent to which a corresponding one of the products accords with a corresponding one of the plurality of partiality vectors. The foregoing information can be stored in a memory to which the control circuit operably couples.

### RELATED APPLICATIONS

This application claims the benefit of each of the following U.S. Provisional applications, each of which is incorporated herein by reference in its entirety: 62/323,026 filed Apr. 15, 2016 (Attorney Docket No. 8842-137893-USPR 1235US01); 62/348,444 filed Jun. 10, 2016 (Attorney Docket No. 8842-138849-USPR 3677US01); 62/436,842 filed Dec. 20, 2016 (Attorney Docket No. 8842-140072-USPR 3678US01); 62/485,045, filed Apr. 13, 2017 (Attorney Docket No. 8842-140820-USPR 4211US01); 62/406,487 filed Oct. 11, 2016 (Attorney Docket No. 8842-137894-USPR 1236US01); 62/350,312 filed Jun. 15, 2016 (Attorney Docket No. 8842-137877-USPR 1371US01); 62/358,287 filed Jul. 5, 2016 (Attorney Docket No. 8842-138567-USPR 1281US01); 62/360,629 filed Jul. 11, 2016 (Attorney Docket No. 8842-137878-USPR 1370US01); and 62/367,299 filed Jul. 27, 2016 (Attorney Docket No. 8842-138563-USPR 1372US01).

### TECHNICAL FIELD

These teachings relate generally to providing products and services to individuals and in some cases, relates to identifying marketing opportunities.

### BACKGROUND

Various shopping paradigms are known in the art. One approach of long-standing use essentially comprises displaying a variety of different goods at a shared physical location and allowing consumers to view/experience those offerings as they wish to thereby make their purchasing selections. This model is being increasingly challenged due at least in part to the logistical and temporal inefficiencies that accompany this approach and also because this approach does not assure that a product best suited to a particular consumer will in fact be available for that consumer to purchase at the time of their visit.

Increasing efforts are being made to present a given consumer with one or more purchasing options that are selected based upon some preference of the consumer. When done properly, this approach can help to avoid presenting the consumer with things that they might not wish to consider. That said, existing preference-based approaches nevertheless leave much to be desired. Information regarding preferences, for example, may tend to be very product specific and accordingly may have little value apart from use with a very specific product or product category. As a result, while helpful, a preferences-based approach is inherently very limited in scope and offers only a very weak platform by which to assess a wide variety of product and service categories.

In modern retail services there is a need to improve the customer service and/or convenience for the customer. One aspect of customer convenience is a customer's ability to find desired products. There are numerous ways to allow a customer to shop. However, there is a need to improve a customer's ability to shop.

It is also known to provide a customer with an opportunity to agree to receive periodic (such as monthly) shipments (for example, at their home or place of employment) of a selected commodity or service on a subscription-like basis. The above-noted concerns are often amplified in this context because the customer can feel the burden of the ongoing commitment and can be even less inclined to enter into such an arrangement for fear of the inconvenience and logistical challenges of exiting that arrangement if the procured product/service fails to meet the customer's needs.

### BRIEF DESCRIPTION OF THE DRAWINGS

The above needs are at least partially met through provision of the vector-based characterizations of products described in the following detailed description, particularly when studied in conjunction with the drawings, wherein:

FIG. 1 comprises a flow diagram as configured in accordance with various embodiments of these teachings;

FIG. 2 comprises a flow diagram as configured in accordance with various embodiments of these teachings;

FIG. 3 comprises a graphic representation as configured in accordance with various embodiments of these teachings;

FIG. 4 comprises a graph as configured in accordance with various embodiments of these teachings;

FIG. 5 comprises a flow diagram as configured in accordance with various embodiments of these teachings;

FIG. 6 comprises a graphic representation as configured in accordance with various embodiments of these teachings;

FIG. 7 comprises a graphic representation as configured in accordance with various embodiments of these teachings;

FIG. 8 comprises a graphic representation as configured in accordance with various embodiments of these teachings;

FIG. 9 comprises a flow diagram as configured in accordance with various embodiments of these teachings;

FIG. 10 comprises a flow diagram as configured in accordance with various embodiments of these teachings;

FIG. 11 comprises a graphic representation as configured in accordance with various embodiments of these teachings;

FIG. 12 comprises a graphic representation as configured in accordance with various embodiments of these teachings;

FIG. 13 comprises a block diagram as configured in accordance with various embodiments of these teachings;

FIG. 14 comprises a flow diagram as configured in accordance with various embodiments of these teachings;

FIG. 15 comprises a graph as configured in accordance with various embodiments of these teachings;

FIG. 16 comprises a flow diagram as configured in accordance with various embodiments of these teachings;

FIG. 17 comprises a block diagram as configured in accordance with various embodiments of these teachings;

FIG. 18 comprises a flow diagram as configured in accordance with various embodiments of the invention;

FIG. 19 comprise a flow diagram as configured in accordance with various embodiments of these teachings;

FIG. 20 comprises a block diagram as configured in accordance with various embodiments of these teachings; and

FIG. 21 comprises a flow diagram as configured in accordance with various embodiments of these teachings.

FIG. 22 is a block diagram in accordance with several embodiments;

FIG. 23 is a flow diagram in accordance with several embodiments;

FIG. 24 is a flow diagram in accordance with several embodiments;

FIG. 25 is a block diagram in accordance with several embodiments;

FIG. 26 is a flow diagram in accordance with several embodiments;

FIG. 27 comprises a flow diagram as configured in accordance with various embodiments of these teachings;

FIG. 28 comprises a block diagram as configured in accordance with various embodiments of these teachings;

FIG. 29 comprises a block diagram as configured in accordance with various embodiments of these teachings;

FIG. 30 comprises a flow diagram as configured in accordance with various embodiments of these teachings;

FIG. 31 is a diagram depicting example operations for selecting a good or a service for a customer 3106 based on the customer's 3106 partialities, according to some embodiments;

FIG. 32 is block diagram of an example system 3200 for selecting a good or a service for a customer based on the customer's partialities, according to some embodiments; and

FIG. 33 is a flow diagram depicting example operations for selecting a good or service for a customer based on the customer's partialities.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, many of these embodiments provide for a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality. This memory can also contain vectorized characterizations for each of a plurality of products, wherein each of the vectorized characterizations includes a measure regarding an extent to which a corresponding one of the products accords with a corresponding one of the plurality of partiality vectors.

Rules can then be provided that use the aforementioned information in support of a wide variety of activities and results. Although the described vector-based approaches bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

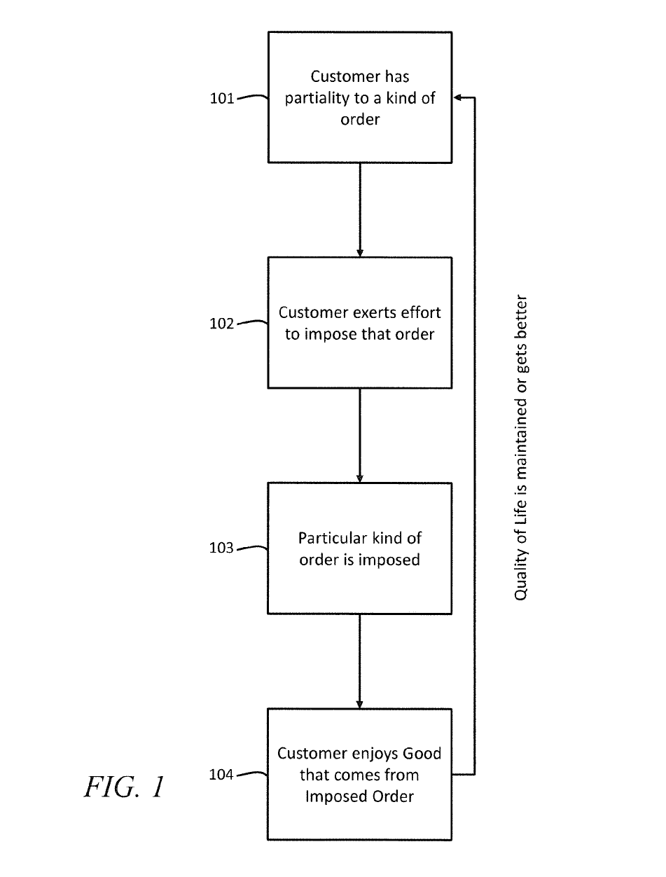

FIG. 1 provides a simple illustrative example in these regards. At block 101 it is understood that a particular person has a partiality (to a greater or lesser extent) to a particular kind of order. At block 102 that person willingly exerts effort to impose that order to thereby, at block 103, achieve an arrangement to which they are partial. And at block 104, this person appreciates the “good” that comes from successfully imposing the order to which they are partial, in effect establishing a positive feedback loop.

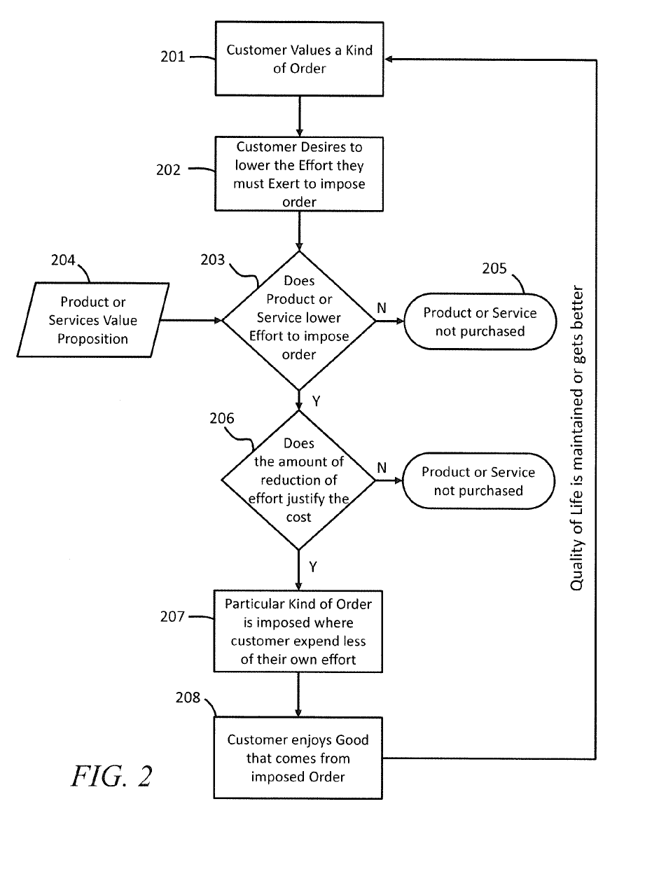

Understanding these partialities to particular kinds of order can be helpful to understanding how receptive a particular person may be to purchasing a given product or service. FIG. 2 provides a simple illustrative example in these regards. At block 201 it is understood that a particular person values a particular kind of order. At block 202 it is understood (or at least presumed) that this person wishes to lower the effort (or is at least receptive to lowering the effort) that they must personally exert to impose that order. At decision block 203 (and with access to information 204 regarding relevant products and or services) a determination can be made whether a particular product or service lowers the effort required by this person to impose the desired order. When such is not the case, it can be concluded that the person will not likely purchase such a product/service 205 (presuming better choices are available).

When the product or service does lower the effort required to impose the desired order, however, at block 206 a determination can be made as to whether the amount of the reduction of effort justifies the cost of purchasing and/or using the proffered product/service. If the cost does not justify the reduction of effort, it can again be concluded that the person will not likely purchase such a product/service 205. When the reduction of effort does justify the cost, however, this person may be presumed to want to purchase the product/service and thereby achieve the desired order (or at least an improvement with respect to that order) with less expenditure of their own personal effort (block 207) and thereby achieve, at block 208, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

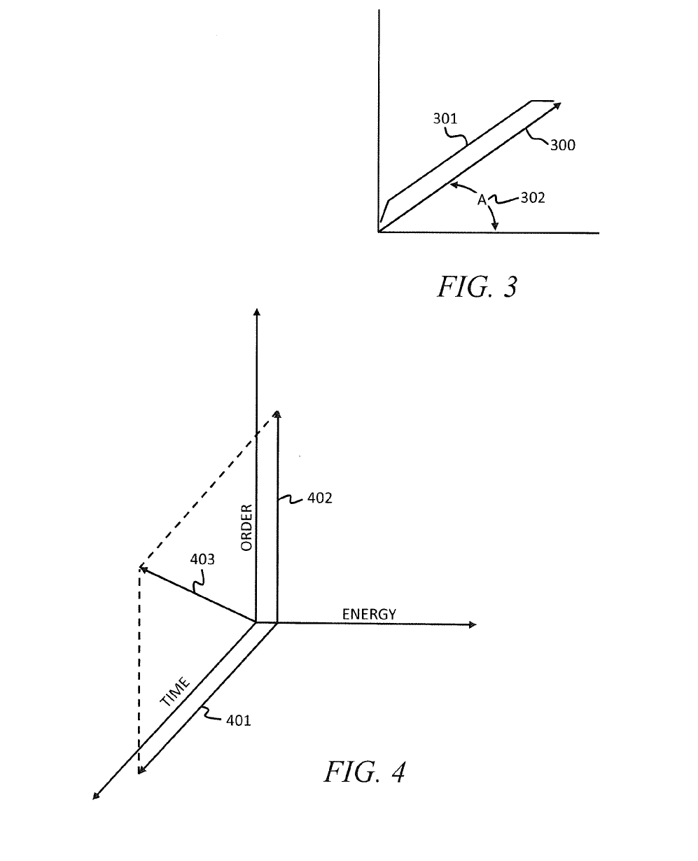

FIG. 3 provides some illustrative examples in these regards. By one approach the vector 300 has a corresponding magnitude 301 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 301, the greater the strength of that belief and vice versa. Per another example, the vector 300 has a corresponding angle A 302 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

FIG. 4 presents a space graph that illustrates many of the foregoing points. A first vector 401 represents the time required to make such a wristwatch while a second vector 402 represents the order associated with such a device (in this case, that order essentially represents the skill of the craftsman). These two vectors 401 and 402 in turn sum to form a third vector 403 that constitutes a value vector for this wristwatch. This value vector 403, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ \begin{matrix}{W}_{1} & … & {W}_{n}\end{matrix} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience).

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

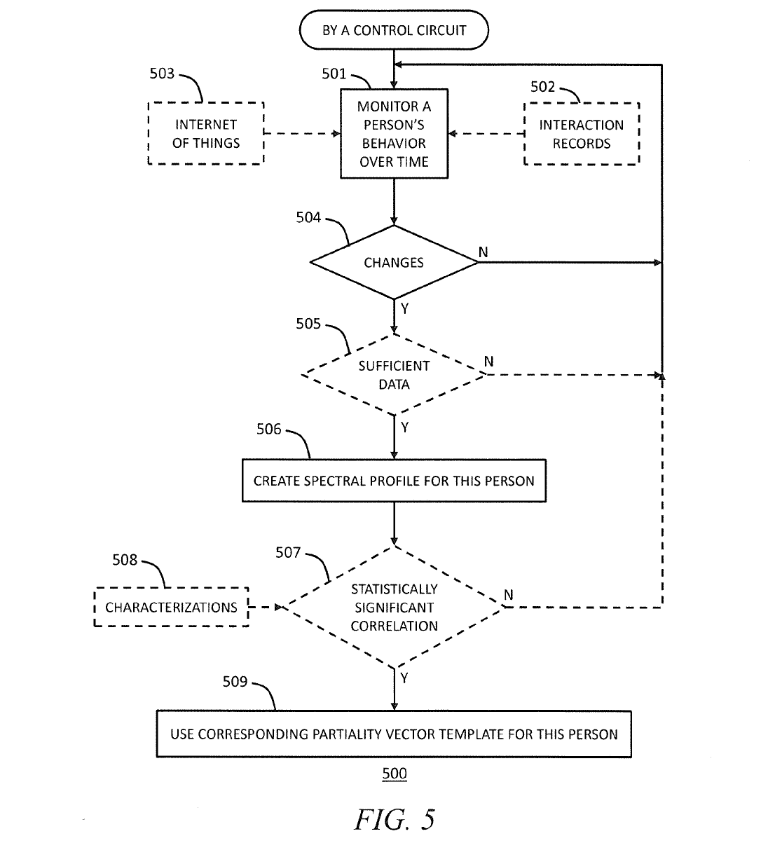

FIG. 5 presents a process 500 that illustrates yet another approach in these regards. For the sake of an illustrative example it will be presumed here that a control circuit of choice (with useful examples in these regards being presented further below) carries out one or more of the described steps/actions.

At block 501 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 502 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 502 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (IOT) 503. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020. (Further description in these regards appears further herein.)

Depending upon what sensors a person encounters, information can be available regarding a person's travels, lifestyle, calorie expenditure over time, diet, habits, interests and affinities, choices and assumed risks, and so forth. This process 500 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 504 this process 500 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 505 this process 500 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

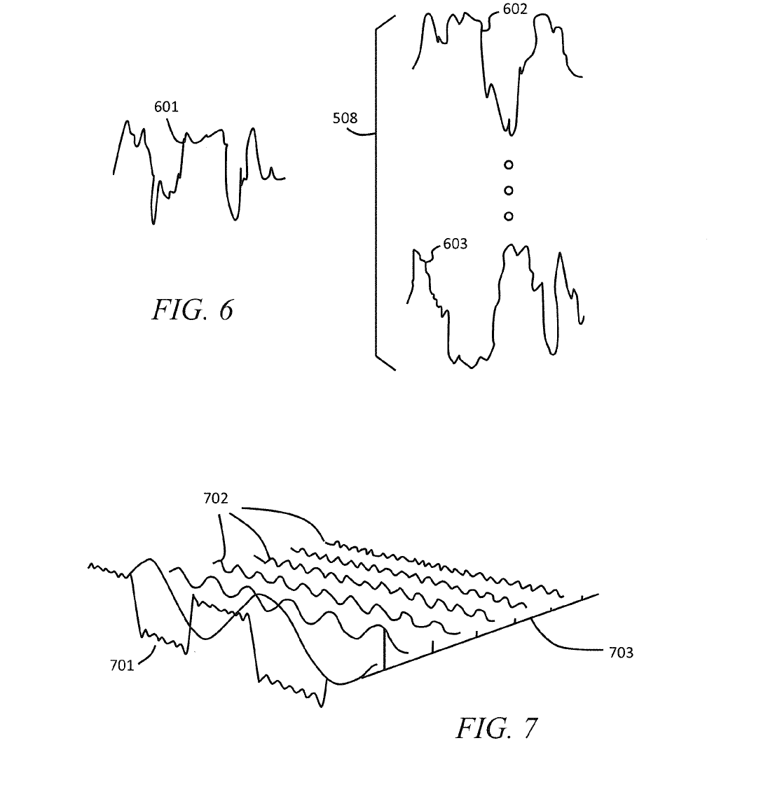

At block 507 this process 500 uses these detected changes to create a spectral profile for the monitored person. FIG. 6 provides an illustrative example in these regards with the spectral profile denoted by reference numeral 601. In this illustrative example the spectral profile 601 represents changes to the person's behavior over a given period of time (such as an hour, a day, a week, or some other temporal window of choice). Such a spectral profile can be as multidimensional as may suit the needs of a given application setting.

At optional block 507 this process 500 then provides for determining whether there is a statistically significant correlation between the aforementioned spectral profile and any of a plurality of like characterizations 508. The like characterizations 508 can comprise, for example, spectral profiles that represent an average of groupings of people who share many of the same (or all of the same) identified partialities. As a very simple illustrative example in these regards, a first such characterization 602 might represent a composite view of a first group of people who have three similar partialities but a dissimilar fourth partiality while another of the characterizations 603 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 508 are based and/or the amount of data and/or the duration of time over which data is available for the monitored person.

Referring now to FIG. 7, by one approach the selected characterization (denoted by reference numeral 701 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 701 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 7 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 7) in the same sense as, for example, a radio or acoustic wave, it will nevertheless be understood that such a behavioral characterization 701 can itself be broken down into a plurality of sub-waves 702 that, when summed together, equal or at least approximate to some satisfactory degree the behavioral characterization 701 itself (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 703 wherein the X axis represents frequency and the Y axis represents the magnitude of the response of the monitored person at each frequency/sub-wave of interest.

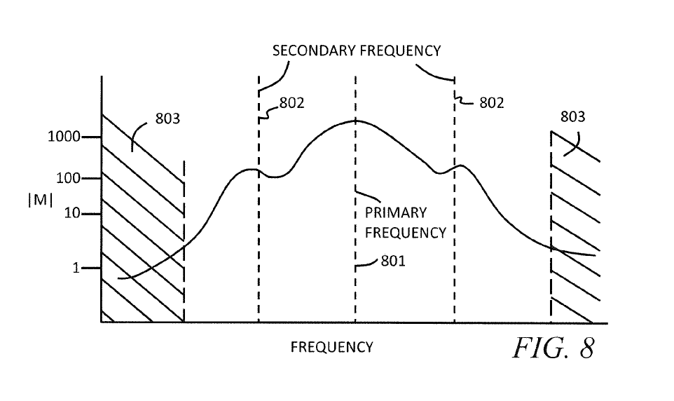

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 8, for many people the spectral profile of the individual person will exhibit a primary frequency 801 for which the greatest response (perhaps many orders of magnitude greater than other evident frequencies) to life is exhibited and apparent. In addition, the spectral profile may also possibly identify one or more secondary frequencies 802 above and/or below that primary frequency 801. (It may be useful in many application settings to filter out more distant frequencies 803 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 701, those partialities can be used as an initial template for a person whose own behaviors permit the selection of that particular characterization 701. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product)

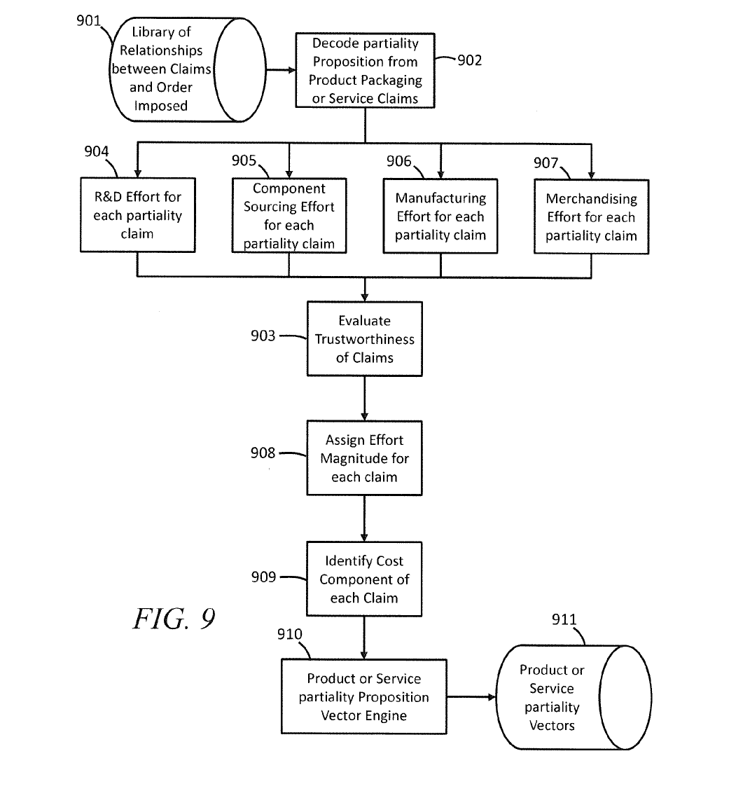

FIG. 9 presents one non-limiting illustrative example in these regards. The illustrated process presumes the availability of a library 901 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 902 this process provides for decoding one or more partiality propositions from specific product packaging (or service claims). For example, the particular textual/graphics-based claims presented on the packaging of a given product can be used to access the aforementioned library 901 to identify one or more corresponding imposed orders from which one or more corresponding partialities can then be identified.

At block 903 this process provides for evaluating the trustworthiness of the aforementioned claims. This evaluation can be based upon any one or more of a variety of data points as desired. FIG. 9 illustrates four significant possibilities in these regards. For example, at block 904 an actual or estimated research and development effort can be quantified for each claim pertaining to a partiality. At block 905 an actual or estimated component sourcing effort for the product in question can be quantified for each claim pertaining to a partiality. At block 906 an actual or estimated manufacturing effort for the product in question can be quantified for each claim pertaining to a partiality. And at block 907 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 908 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 909 this process provides for identifying a cost component of each claim, this cost component representing a monetary value. At block 910 this process can use the foregoing information with a product/service partiality propositions vector engine to generate a library 911 of one or more corresponding partiality vectors for the processed products/services. Such a library can then be used as described herein in conjunction with partiality vector information for various persons to identify, for example, products/services that are well aligned with the partialities of specific individuals.

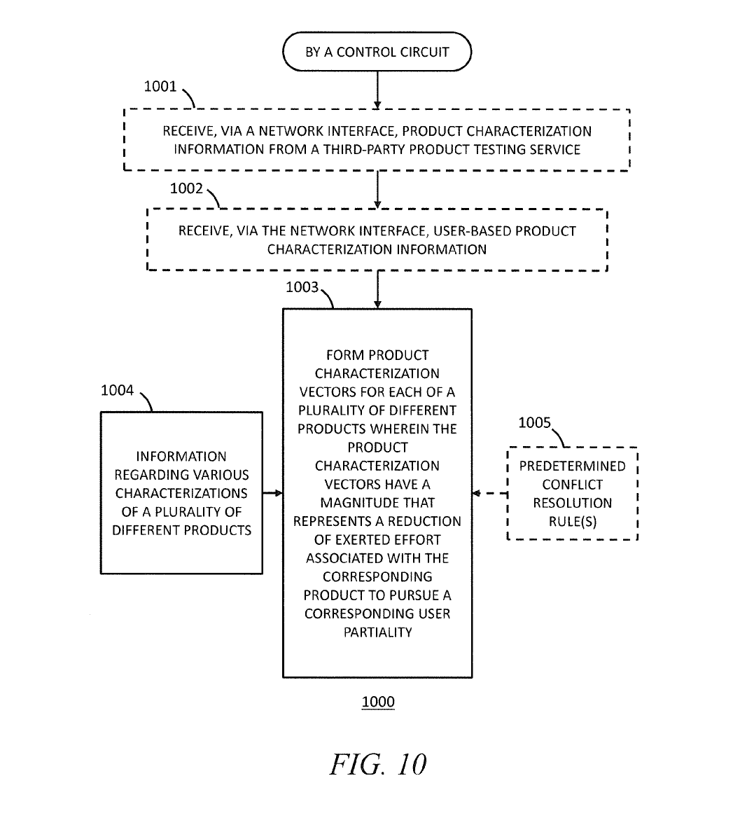

FIG. 10 provides another illustrative example in these same regards and may be employed in lieu of the foregoing or in total or partial combination therewith. Generally speaking, this process 1000 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 10, this process 1000 can be carried out by a control circuit of choice. Specific examples of control circuits are provided elsewhere herein.

As described further herein in detail, this process 1000 makes use of information regarding various characterizations of a plurality of different products. These teachings are highly flexible in practice and will accommodate a wide variety of possible information sources and types of information. By one optional approach, and as shown at optional block 1001, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself.)

As another example, and as illustrated at optional block 1002, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1000 provides for accessing (see block 1004) information regarding various characterizations of each of a plurality of different products. This information 1004 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1004 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1003 the control circuit uses the foregoing information 1004 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1004. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1005 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1004 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

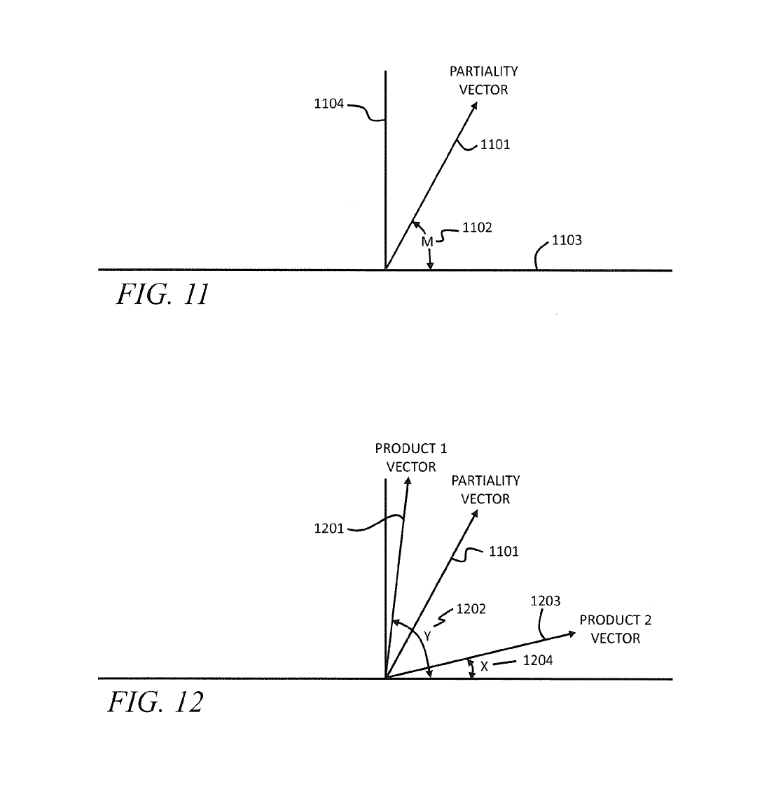

As noted above, the magnitude corresponding to a particular partiality vector for a particular person can be expressed by the angle of that partiality vector. FIG. 11 provides an illustrative example in these regards. In this example the partiality vector 1101 has an angle M 1102 (and where the range of available positive magnitudes range from a minimal magnitude represented by 0° (as denoted by reference numeral 1103) to a maximum magnitude represented by 90° (as denoted by reference numeral 1104)). Accordingly, the person to whom this partiality vector 1001 pertains has a relatively strong (but not absolute) belief in an amount of good that comes from an order associated with that partiality.

FIG. 12, in turn, presents that partiality vector 1101 in context with the product characterization vectors 1201 and 1203 for a first product and a second product, respectively. In this example the product characterization vector 1201 for the first product has an angle Y 1202 that is greater than the angle M 1102 for the aforementioned partiality vector 1101 by a relatively small amount while the product characterization vector 1203 for the second product has an angle X 1204 that is considerably smaller than the angle M 1102 for the partiality vector 1101.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1201 with the partiality vector 1101 will be larger than the resultant scaler value for the vector dot product of the product 2 vector 1203 with the partiality vector 1101. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv·P1v) might equal (1,1), hence yielding a scalar result of ∥1∥ (where Cv refers to the corresponding partiality vector for this person and P1v represents the corresponding product characterization vector for these organic apples). Conversely, a dot product result for this same person with respect to a product characterization vector(s) for non-organic apples that represent a cost of $5 on a weekly basis (i.e., Cv·P2v) might instead equal (1,0), hence yielding a scalar result of ∥½∥. Accordingly, although the organic apples cost more than the non-organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥½)), but the dot product for the $10/week organic apples may now drop (for example, to ∥½∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

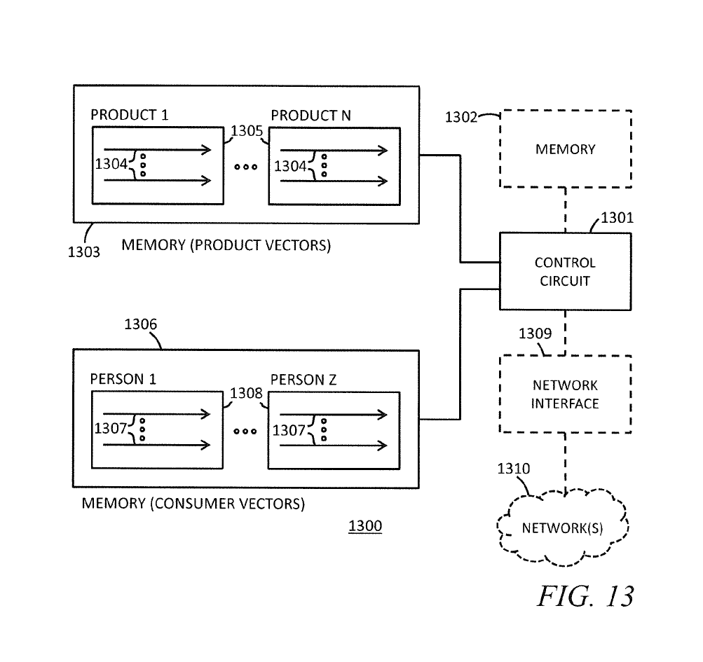

FIG. 13 presents an illustrative apparatus 1300 for conducting, containing, and utilizing the foregoing content and capabilities. In this particular example, the enabling apparatus 1300 includes a control circuit 1301. Being a “circuit,” the control circuit 1301 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1301 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1301 is configured (for example, by using corresponding programming as will be well understood by those skilled in the art) to carry out one or more of the steps, actions, and/or functions described herein.

By one optional approach the control circuit 1301 operably couples to a memory 1302. This memory 1302 may be integral to the control circuit 1301 or can be physically discrete (in whole or in part) from the control circuit 1301 as desired. This memory 1302 can also be local with respect to the control circuit 1301 (where, for example, both share a common circuit board, chassis, power supply, and/or housing) or can be partially or wholly remote with respect to the control circuit 1301 (where, for example, the memory 1302 is physically located in another facility, metropolitan area, or even country as compared to the control circuit 1301).

This memory 1302 can serve, for example, to non-transitorily store the computer instructions that, when executed by the control circuit 1301, cause the control circuit 1301 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Either stored in this memory 1302 or, as illustrated, in a separate memory 1303 are the vectorized characterizations 1304 for each of a plurality of products 1305 (represented here by a first product through an Nth product where “N” is an integer greater than “1”). In addition, and again either stored in this memory 1302 or, as illustrated, in a separate memory 1306 are the vectorized characterizations 1307 for each of a plurality of individual persons 1308 (represented here by a first person through a Zth person wherein “Z” is also an integer greater than “1”).

In this example the control circuit 1301 also operably couples to a network interface 1309. So configured the control circuit 1301 can communicate with other elements (both within the apparatus 1300 and external thereto) via the network interface 1309. Network interfaces, including both wireless and non-wireless platforms, are well understood in the art and require no particular elaboration here. This network interface 1309 can compatibly communicate via whatever network or networks 1310 may be appropriate to suit the particular needs of a given application setting. Both communication networks and network interfaces are well understood areas of prior art endeavor and therefore no further elaboration will be provided here in those regards for the sake of brevity.

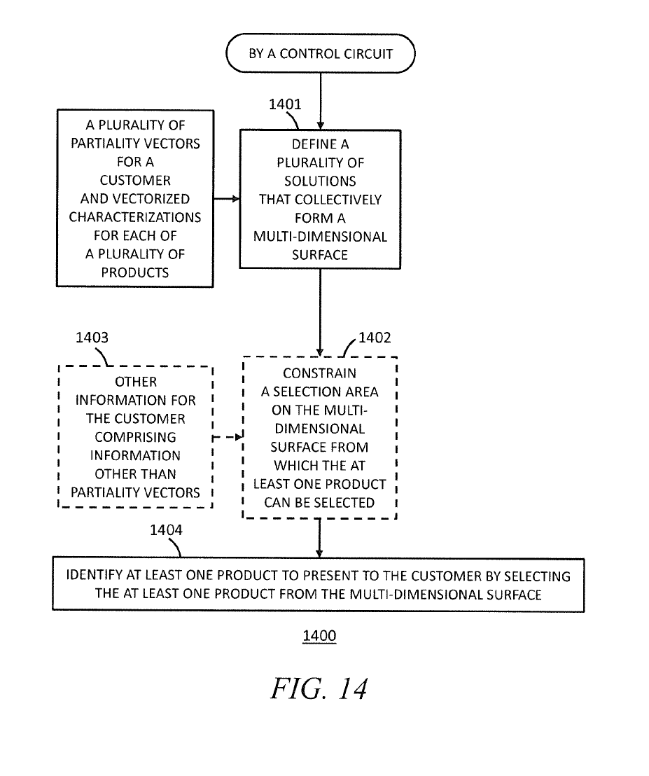

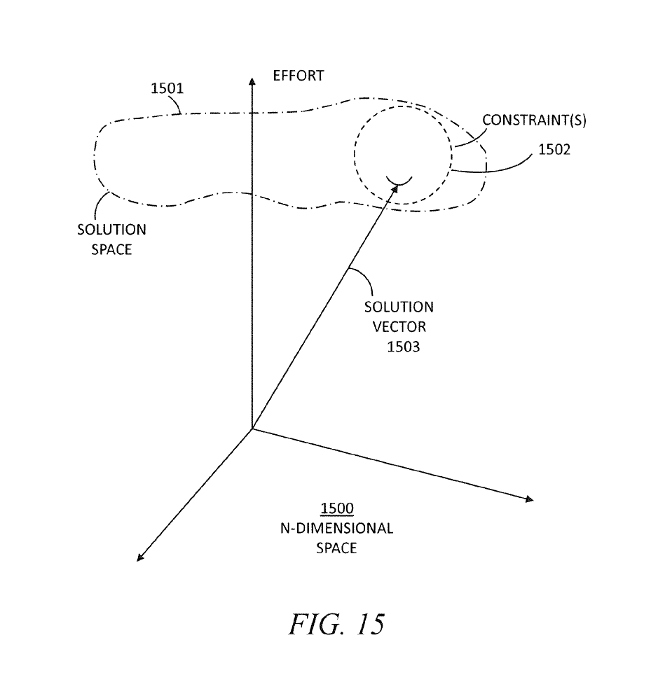

By one approach, and referring now to FIG. 14, the control circuit 1301 is configured to use the aforementioned partiality vectors 1307 and the vectorized product characterizations 1304 to define a plurality of solutions that collectively form a multidimensional surface (per block 1401). FIG. 15 provides an illustrative example in these regards. FIG. 15 represents an N-dimensional space 1500 and where the aforementioned information for a particular customer yielded a multi-dimensional surface denoted by reference numeral 1501. (The relevant value space is an N-dimensional space where the belief in the value of a particular ordering of one's life only acts on value propositions in that space as a function of a least-effort functional relationship.)

Generally speaking, this surface 1501 represents all possible solutions based upon the foregoing information. Accordingly, in a typical application setting this surface 1501 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 14 and 15, at optional block 1402 the control circuit 1301 can be configured to use information for the customer 1403 (other than the aforementioned partiality vectors 1307) to constrain a selection area 1502 on the multi-dimensional surface 1501 from which at least one product can be selected for this particular customer. By one approach, for example, the constraints can be selected such that the resultant selection area 1502 represents the best 95th percentile of the solution space. Other target sizes for the selection area 1502 are of course possible and may be useful in a given application setting.

The aforementioned other information 1403 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or planned/scheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1502), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1404 the control circuit 1301 can then identify at least one product to present to the customer by selecting that product from the multi-dimensional surface 1501. In the example of FIG. 15, where constraints have been used to define a reduced selection area 1502, the control circuit 1301 is constrained to select that product from within that selection area 1502. For example, and in accordance with the description provided herein, the control circuit 1301 can select that product via solution vector 1503 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1301 may respond per these teachings to learning that the customer is planning a party that will include seven other invited individuals. The control circuit 1301 may therefore be looking to identify one or more particular beverages to present to the customer for consideration in those regards. The aforementioned partiality vectors 1307 and vectorized product characterizations 1304 can serve to define a corresponding multi-dimensional surface 1501 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1502 to beverages that contain no alcohol. As another example in these regards, the control circuit 1301 may have objective information that the party is to be held in a state park that prohibits alcohol and may therefore similarly constrain the available selection area 1502 to beverages that contain no alcohol.

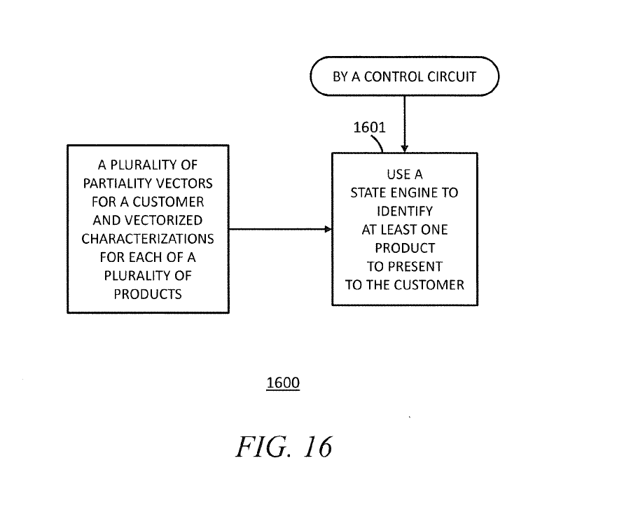

As described above, the aforementioned control circuit 1301 can utilize information including a plurality of partiality vectors for a particular customer along with vectorized product characterizations for each of a plurality of products to identify at least one product to present to a customer. By one approach 1600, and referring to FIG. 16, the control circuit 1301 can be configured as (or to use) a state engine to identify such a product (as indicated at block 1601). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

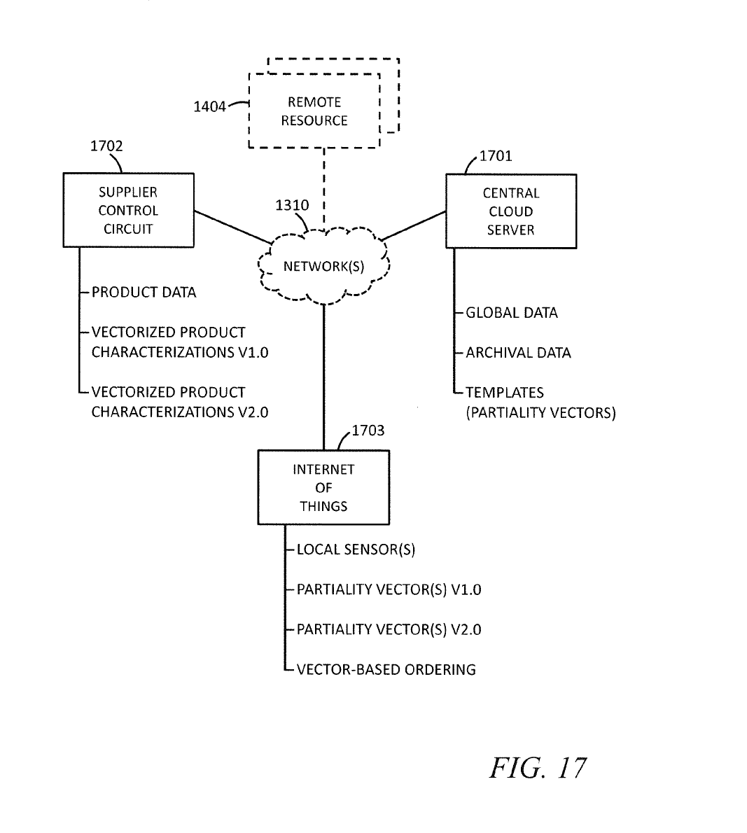

It will be appreciated that the apparatus 1300 described above can be viewed as a literal physical architecture or, if desired, as a logical construct. For example, these teachings can be enabled and operated in a highly centralized manner (as might be suggested when viewing that apparatus 1300 as a physical construct) or, conversely, can be enabled and operated in a highly decentralized manner. FIG. 17 provides an example as regards the latter.

In this illustrative example a central cloud server 1701, a supplier control circuit 1702, and the aforementioned Internet of Things 1703 communicate via the aforementioned network 1310.

The central cloud server 1701 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 1701 that store identical, overlapping, or wholly distinct content.)

The supplier control circuit 1702 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 17 by the expression “vectorized product characterizations V1.0”) for a given product as well as subsequent, updated vectorized product characterizations (denoted in FIG. 17 by the expression “vectorized product characterizations V2.0”) for the same product. Such modifications may have been made by the supplier control circuit 1702 itself or may have been made in conjunction with or wholly by an external resource as desired.

The Internet of Things 1703 can comprise any of a variety of devices and components that may include local sensors that can provide information regarding a corresponding user's circumstances, behaviors, and reactions back to, for example, the aforementioned central cloud server 1701 and the supplier control circuit 1702 to facilitate the development of corresponding partiality vectors for that corresponding user. Again, however, these teachings will also support a decentralized approach. In many cases devices that are fairly considered to be members of the Internet of Things 1703 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 1702 and use that information in conjunction with local partiality vector information to facilitate the vector-based ordering.

Also, if desired, the smart phone in this example can itself modify and update partiality vectors for the corresponding user. To illustrate this idea in FIG. 17, this device can utilize, for example, information gained at least in part from local sensors to update a locally-stored partiality vector (represented in FIG. 17 by the expression “partiality vector V1.0”) to obtain an updated locally-stored partiality vector (represented in FIG. 17 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 1704. These remote resources 1704 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

A person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

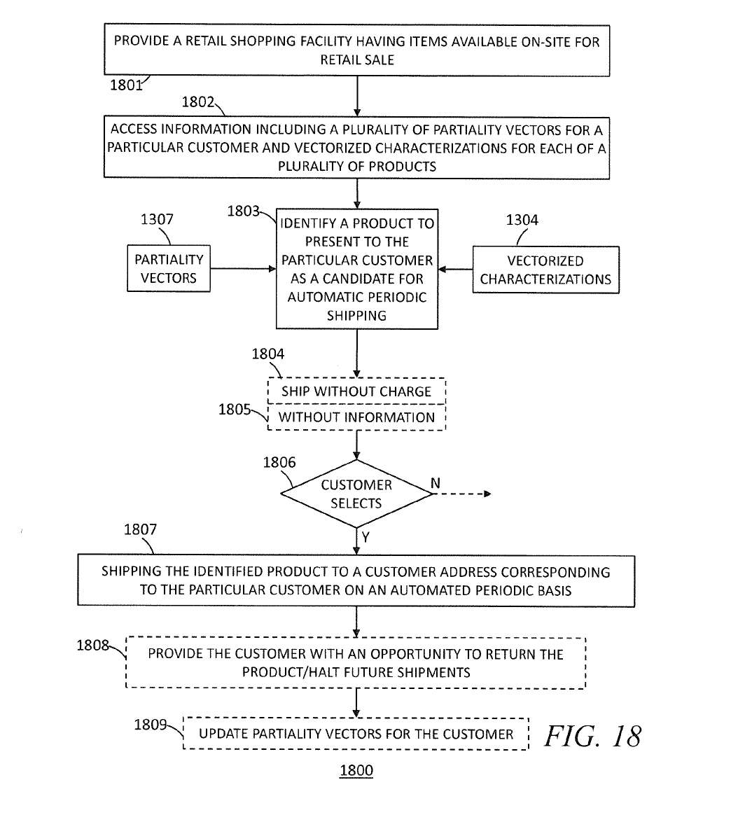

FIG. 18 presents another illustrative example as regards the use and leveraging of the aforementioned partiality vectors 1307 and the vectorized characterizations 1304 for corresponding products 1305.

At block 1801 this process provides a retail shopping facility having items available on-site for retail sale. As used herein, the expression “retail shopping facility” will be understood to refer to a retail sales facility or any other type of bricks-and-mortar (i.e., physical) facility in which products are physically displayed and offered for sale to customers who physically visit the facility. The shopping facility may include one or more of sales floor areas, checkout locations (i.e., point of sale (POS) locations), customer service areas other than checkout locations (such as service areas to handle returns), parking locations, entrance and exit areas, stock room areas, stock receiving areas, hallway areas, common areas shared by merchants, and so on. The facility may be any size or format of facility, and may include products from one or more merchants. For example, a facility may be a single store operated by one merchant or may be a collection of stores covering multiple merchants such as a mall.

One, some, or all of the remaining steps of this process 1800 can be carried out, in whole or in part as desired, by a control circuit of choice (such as but not limited to the aforementioned control circuit 1301).

At block 1802 the control circuit 1301 accesses information including the aforementioned plurality of partiality vectors 1307 for a particular customer as well as vector characterizations 1304 for each of a plurality of products 1305. As explained above, these vectorized characterizations 1304 indicate a measure regarding an extent to which a corresponding one of the products 1305 accords with a corresponding one of the plurality of partiality vectors 1307. The control circuit 1301 can access this information, for example, by accessing the aforementioned memories 1303 and 1306.

At block 1803 the control circuit 1301 uses the foregoing information to identify a product to present to the particular customer as a candidate for automatic periodic shipping. It should be noted that, by one approach, this identified product may or may not comprise one of the items made available at the aforementioned retail shopping facility. This activity may comprise identifying only one such candidate product or, if desired, a plurality of categorically related or unrelated products.

By one approach the foregoing selection activity can be based, at least in part, upon the control circuit 1301 predicting that the particular customer will keep the identified product upon receipt thereof. This prediction, in turn, can be based upon the aforementioned corresponding partiality vectors for this particular customer and the vectorized characterizations for the candidate products. By one approach, this prediction can be made in a useful way per these teachings notwithstanding that it may not be known if this particular customer has ever previously made a purchasing decision regarding the particular one of the plurality of products (as an individual purchase or as a purchase made on an on-going automated basis).

By one approach, and as shown at optional step 1804, this process 1800 will accommodate selecting the identified product to ship to the particular customer without charge to that customer and without that customer having ordered the identified product. In particular, the identified product can be shipped to the particular customer without seeking reimbursement for either the product itself or for any of the corresponding shipping charges. Such a shipment may be provided to the customer with or without preliminary notice as desired.

When providing a selected product to a customer without charge, this process 1800 will also accommodate (as shown at optional block 1805) providing information to this customer that explains how this particular product specifically accords with at least one partiality of the customer. As one simple example in these regards, such information can explain how this particular product specifically serves a particular value believed to be important to this customer. This information can be provided with the product itself or can be provided separately. When provided separately, the customer may be provided, for example, with a link or web address that will lead a customer's network device to a site or webpage that provides such information. The information can comprise both text and non-textual content as desired.

In any event, at block 1806 the control circuit 1301 detects when this customer selects to receive the identified product via an automatic periodic shipment. When the customer has received a free shipment of the identified product as described above, the customer's selection may be provided via a corresponding website, mobile-device application, telephone response, an in-store response provided, for example, at a customer service area of the aforementioned retail shopping facility, or otherwise as desired. In other cases, the customer's selection can be offered (and then so detected) in a manner corresponding to and/or as appropriate to the selection mechanism. (In the absence of detecting this trigger event this process 1800 can accommodate any of a variety of responses. Examples of salient responses can include temporal multitasking (pursuant to which the control circuit 1301 conducts other tasks before returning to again monitor for this customer selection) as well as continually looping back to essentially continuously monitor for the trigger event. These teachings also accommodate supporting this detection activity via a real-time interrupt capability.)

In response to this detection, and as illustrated at block 1807, this process provides for shipping the identified product to a customer address that corresponds to this particular customer (such as their residential address, their place of employment, or other location of choice) on an automated periodic basis. These teachings are highly flexible in this regard and will accommodate a variety of corresponding approaches. For example, the “periodic” nature of these shipments can be weekly, monthly, quarterly, or some other fixed calendar-based periodicity. By another approach the timing of the shipments can be based upon estimated or actually-measured usage of the product by the customer. As a result, it is possible for the periodicity to fluctuate somewhat with the customer's usage and/or actual or predicted needs.

If desired, and as illustrated at optional block 1808, these teachings will accommodate providing the customer with an opportunity to return the identified product following an automated periodic shipment thereof. By one approach, if desired, this activity can include also providing the customer with an opportunity to indicate at least one reason for returning the identified product.

This opportunity can further include the opportunity to halt future automated periodic shipments of the identified product if desired. By one approach this opportunity can comprise an opportunity to only-temporarily halt future automated periodic shipments of the identified product (to accommodate, for example, the customer's vacation schedule or some other periodic variation in their activities and needs). In lieu of the foregoing or in combination therewith, by another approach this opportunity can comprise an opportunity to non-temporarily halt future automated periodic shipments of the identified product. In this case, and again if desired, the latter can include also providing the customer with an opportunity to indicate at least one reason for returning the identified product.

As another optional approach, and as illustrated at block 1809, this process 1800 will accommodate updating the partiality vectors 1307 for this particular customer in response to the customer, for example, returning an identified product that was shipped to them without charge, returning an identified product that has been shipped pursuant to an automated periodic shipment regimen, and/or temporarily or non-temporarily halting the future automated periodic shipments of the identified product. Updating the partiality vector information for the customer may be particularly appropriate when the customer has provided one or more reasons for their action. Updating the partiality vector information may comprise, for example, adding a new partiality to the customer's profile and/or modifying an existing partiality by, for example, adjusting the magnitude of the vector towards an existing partiality.

So configured, the aforementioned partiality vectors and vectorized product characterizations can be leveraged to identify particular products for a particular customer that are especially appropriate to consider offering to the customer pursuant to an automatic periodic shipping arrangement.

In some embodiments, systems, apparatuses, and methods are provided herein for processing returns. A system for managing deliveries comprises a customer profile database, a product database, and a control circuit coupled to the customer profile database and the product database. The control circuit being configured to retrieve at least one customer value vector associated with a customer from the customer profile database storing customer partiality vectors for a plurality of customers, the customer partiality vectors comprise customer value vectors, compare the at least one customer value vector with vectorized product characterizations of a plurality of items in the product database to select one or more items compatible with the at least one customer value vector to deliver to the customer, and instruct the one or more items to be delivered to the customer.

With subscription home delivery services, the customer may receive a delivery of one or more items selected for them by a seller. The customer may elect to accept some or none of the items delivered and may only be charged for the items they accept. Items that are not accepted by the customer may be retrieved during the next delivery and brought back to one or more of a retail, storage, distribution, or dispatch facility.

In one embodiment, a system for managing deliveries comprises a customer profile database, a product database, and a control circuit coupled to the customer profile database and the product database. The control circuit being configured to retrieve at least one customer value vector associated with a customer from the customer profile database storing customer partiality vectors for a plurality of customers, the customer partiality vectors comprise customer value vectors, compare the at least one customer value vector with vectorized product characterizations of a plurality of items in the product database to select one or more items compatible with the at least one customer value vector to deliver to the customer, and instruct the one or more items to be delivered to the customer.

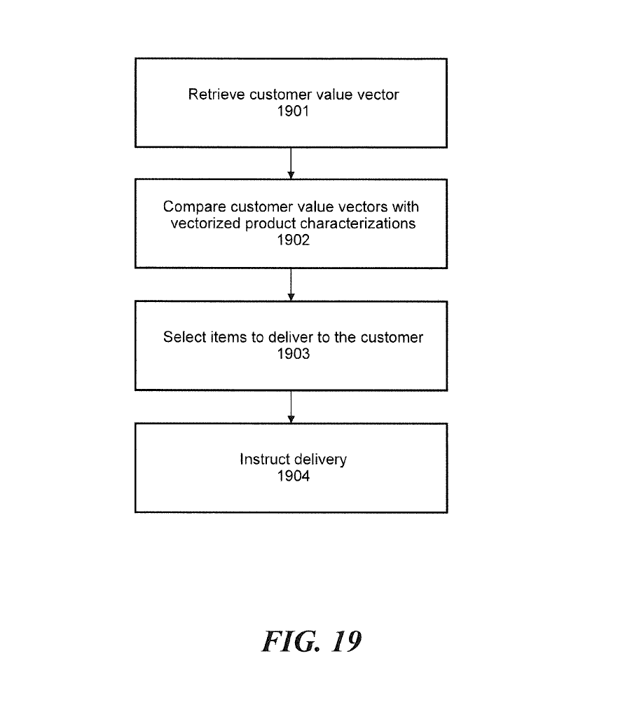

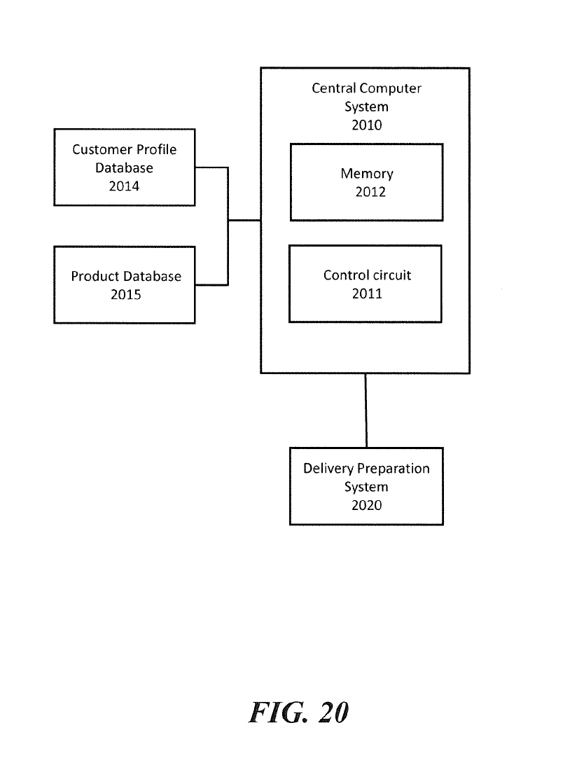

Referring next to FIG. 19, a method for managing deliveries according to some embodiments is shown. The steps in FIG. 19 may generally be performed by a processor-based device such as a central computer system, a server, a cloud-based server, a delivery management system, a retail management system, etc. In some embodiments, the steps in FIG. 19 may be performed by one or more of the control circuit 1301 described with reference to FIG. 13, the control circuit 2011, and the delivery preparation system 2020 described with reference to FIG. 20 herein.

In step 1901, the system retrieves customer value vectors associated with a customer. In some embodiments, the customer value vector may be retrieved from a customer profile database storing customer partiality vectors for a plurality of customers. The customer may generally be a customer subscribed to a delivery subscription service. In some embodiments, the customer partiality vectors each represents at least one of a person's values, preferences, affinities, and aspirations. In some embodiments, customer value vectors each comprises a magnitude that corresponds to the customer's belief in good that comes from an order associated with that value. In some embodiments, the customer partiality vectors, including value vectors, may be determined and/or updated with a purchase and/or return history of associated with the customer.

In step 1902, the system compares the customer value vectors with vectorized product characterizations of a plurality of products. In some embodiments, the customer partiality vectors, including customer value vectors, and the vectorized product characterizations may be compared to determine a degree of alignment between the customer and one or more products. In some embodiments, vectorized product characterizations may be stored in the product database. In some embodiments, the alignment between a product and a customer may be determined by adding, subtracting, multiplying, and/or dividing the magnitudes of the corresponding vectors in the customer partiality vectors and product characterization vectors. For example, an alignment score for each vector may be determined by subtracting the magnitude of the customer vector from the magnitude of the associated product characterization vector. In some embodiments, compatibility between the customer and the product may be determined based on whether the scores of each vector exceeds a set score (e.g. 0, −1, etc.). In some embodiments, a score for each vector may be determined by multiplying the magnitudes of the customer vector and the associated product characterization vector. In some embodiments, scores for each vector may be added and/or averaged to determine an overall alignment score. In some embodiments, compatibility between the customer and the product may be determined based on whether the overall alignment score exceeds a threshold.

In step 1902, the system selects items that are compatible with the user's partiality vectors to deliver to the customer. In some embodiments, an item may be considered to be compatible to if the alignment between the customer partiality vectors and the vectorized product characterizations exceeds a threshold. In some embodiments, the system may require that each product characterization vector matches or exceeds the corresponding customer partiality vector. In some embodiments, products may be ranked and/or prioritized for the customer based on the degree of alignment between the customer partiality vectors and the product characterization vectors.

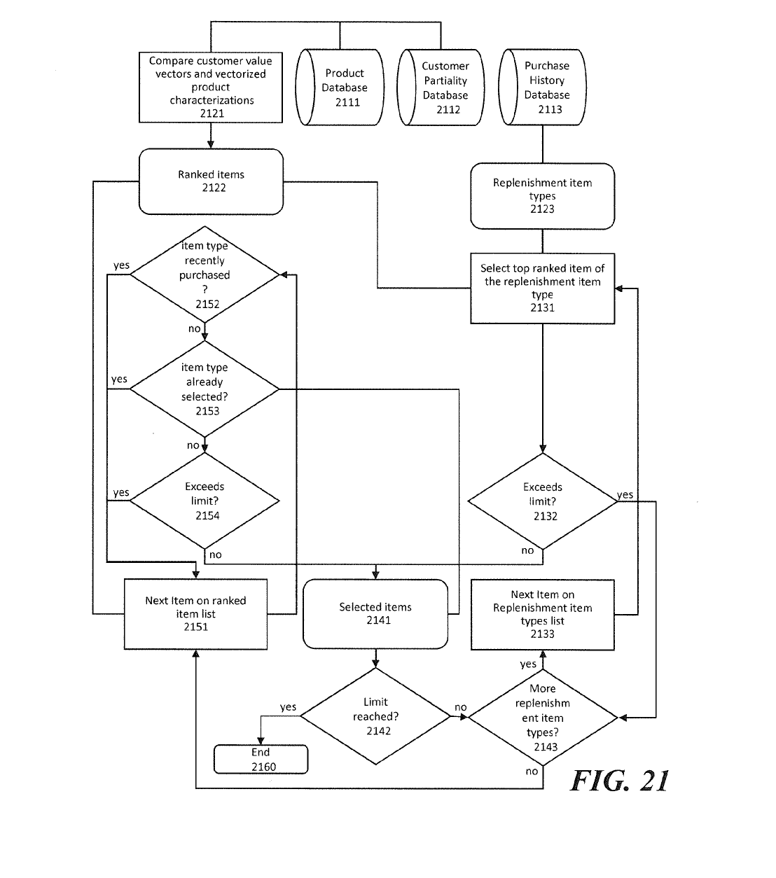

In some embodiments, items may be further be selected based on other considerations such as the customer's recent purchase history, estimated customer inventory level, delivery container capacity, receiving container capacity, item size, item weight, item price, etc. In some embodiments, the system may determine whether the customer may need a replenishment of an item type (e.g. detergent, cooking oil, toilet paper, etc.) based on the customer's purchase history. If replenishment may be needed, the system may select an item of the same type based on customer partiality vectors. In some embodiments, the system may prevent any item that has been recently returned by the customer from being delivered again for at least a period of time. In some embodiments, the system may select only one item of the same item type to include in each shipment. In some embodiments, the system may prioritize items based on staying under a maximum volume, weight, and/or total order price. For example, the system may be configured to make sure that the items selected would fit into a delivery container and/or a receiving container at the customer's premises. In some embodiments, the system may use the customer partiality vectors in combination of other considerations to maximum the chance that delivered items will be accepted and purchased by the customer. An example of the item selection process that includes customer partiality vectors and other considerations is described with reference to FIG. 21 herein.

In some embodiments, the selected items may comprise a product not previously purchased by the customer according to a recorded customer purchase history. For example, the system may use purchase history to determine a user's value, reference, and/or affinity vectors. The vectors may then be used to select an item in a category with no customer purchase data. In some embodiments, the selected item may comprise a replenishment product selected based on a purchase history and/or estimated inventory level of the customer. For example, the system may track the frequency of a customer's purchase of a type of item (e.g. detergent, toilet paper, flour) to determine that the item types may be in need of replenishment. In another example, replenishment items may be determined based on the quantity of the customer's last purchase and an estimated/assumed depletion rate associated with the product.

In step 1904, the system instructs the delivery of the one or more items to the customer. In some embodiments, the instruction may be provided to one or more of an order fulfillment system, a shipment preparation system, an item picker, a distribution center or retail store associate, a distribution center sorting system, and like. For example, the list of items may be displayed and/or printed as a packing list for a picker to assemble the order for delivery. In some embodiments, the instructions may comprise machine instructions to be executed by robots and/or unmanned vehicles for the packing and/or deliverying the items to the customer. In some embodiments, the items may be delivered as part of a reoccurring delivery subscription service.

In some embodiments, after step 1904, the customer may select to accept one or more items delivered to him/her. In some embodiments, the system may process a charge for the one or more items after the customer accepts the delivery of the one or more items. In some embodiments, the system may further be configured to receive a return request from the customer after the delivery of the one or more items and update the partiality vectors, including value vectors, of the customer based on the return request. In some embodiments, the system may update the customer profile and/or partiality vectors of a customer based on the items the customer accepts and/or returns and/or any feedbacks the customer provide regarding the items.

Referring next to FIG. 20, a block diagram of a system according to some embodiments is shown. The system comprises a central computer system 2010, a customer profile database 2014, a product database 2015, and a delivery preparation system 2020.

The central computer system 2010 may comprise a processor-based system such as one or more of a server system, a computer system, a cloud-based server, a delivery management computer system, a retail management system, and the like. The control circuit 2011 may comprise a processor, a central processor unit, a microprocessor, and the like. The memory 2012 may include one or more of a volatile and/or non-volatile computer readable memory devices. In some embodiments, the memory 2012 stores computer executable codes that cause the control circuit 2011 to select one or more items to delivery to a customer based on the information in the customer profile database 2014 and the product database 2015. In some embodiments, the control circuit 2011 may be configured to update the customer partiality vectors in the customer profile database 2014 based on the user's delivery acceptance and/or return histories. In some embodiments, computer executable code may cause the control circuit 2011 to perform one or more steps described with reference to FIGS. 19 and 21 herein.

The central computer system 2010 may be coupled to the customer profile database 2014 and/or the product database 2015 via a wired and/or wireless communication channel. The customer profile database 2014 may be configured store customer profiles for a plurality of customers of a home delivery service. Each customer profile may comprise one or more of customer name, customer address, customer demographic information, and customer partiality vectors. Customer partiality vectors may comprise one or more of a customer value vectors, customer preference vectors, and customer affinity vectors. In some embodiments, the customer partiality vectors may be determined and/or updated based one or more of customer purchase history, customer survey input, customer item return history, and/or customer return comments. In some embodiments, customer partialities determined from a customer's purchase history in one or more product categories and may be used to match the customer to a product in a category from which the customer has not previously made a purchase. For example, customer partialities determined from the customer's purchase of snacks and pet foods may indicate that the user values natural products. The value vector and magnitude associated with natural products may then be used to match the user to products in the beauty and personal care categories.

The product database 2015 may store one or more profiles of products offered for sale through the delivery service. In some embodiments, the products profile may associated product identifiers (e.g. Universal Product Code (UPC), barcode, product name, brand name, etc.) with vectorized product characterizations. In some embodiment, the vectorized product characterizations may comprise one or more of vectors associated with customer values, preferences, affinities, and/or aspirations in reference to the products. For example, a product profile may comprise of vectorized product value characterization that includes a magnitude that corresponds to how well the product aligns with a customer's cruelty-free value vector. In some embodiments, the vectorized product characterizations may be determined by one or more of product packaging description, product ingredients list, product material, product specification, brand reputation, and customer feedback.

While the customer profile database 2014 and the product database 2015 are shown outside the central computer system 2010 in FIG. 20, in some embodiments, the customer profile database 2014 and the product database 2015 may be implemented as part of the central computer system 2010 and/or the memory 2012. In some embodiments, the customer profile database 2014 and the product database 2015 comprise database structures that represent customer partialities and product characterizations, respectively, in vector form.

The delivery preparation system 2020 may comprise a system for preparing shipments for home deliveries. In some embodiments, the delivery preparation system 2020 may comprise one or more of an order fulfillment system, an item picker, a distribution center or retail store associate, a distribution center or retail robot, a distribution center sorting system, and like. In some embodiments, the delivery preparation system 2020 may comprise one or more processor-based devices for displaying and/or carrying out instructions from the central computer system 2010. In some embodiments, the delivery preparation system 2020 may be configured to cause items selected by the central computer system 2010 to be placed into a container/bin designated for the associated customer. In some embodiments, the central computer system 2010 may be coupled to the delivery preparation system 2020 via a wired and/or wireless communication channel. In some embodiments, the delivery preparation system 2020 may be implemented at least partially with the central computer system 2010.

Next referring to FIG. 21, a method of selecting items for a customer is shown. The steps in FIG. 21 may generally be performed by a processor-based device such as a central computer system, a server, a cloud-based server, a delivery management system, a retail management system, etc. In some embodiments, the steps in FIG. 21 may be performed by one or more of the control circuit 1301 described with reference to FIG. 13, the control circuit 2011, and the delivery preparation system 2020 described with reference to FIG. 20 herein.

In step 2121, the system compares customer value vectors stored in the customer partiality database 2112 with product characterizations vectors stored in the product database 2111 to generate a list of ranked items 2122. In some embodiments, the system may determine an alignment score for one or more items in the product database 2015 for a customer based on the customer's partiality vectors. In some embodiments, alignment scores for each vector may be determined by adding, subtracting, multiplying, or dividing the magnitudes of the corresponding vectors. In some embodiments, scores for each vector may be added together and/or averaged to determine an overall alignment score. In some embodiments, items in the list of the ranked items 2122 may be ranked according to their alignment scores. In some embodiments, items may only be included in the list of ranked items 2122 if the magnitude of each product characterization vector matches or exceeds the magnitude of the corresponding customer value vector.

In some embodiments, the system may further generate a list of replenishment item types 2123 based on the customer's purchase history stored in a purchase history database 2113. In some embodiments, the replenishment item types 2123 may be determined by tracking the frequency of a customer's purchase of a type of item (e.g. detergent, toilet paper, flour) to determine that an item type may be in need of replenishment. In some embodiments, replenishment item types 2123 may be determined based on the quantity of the customer's last purchase in the item type and an estimated/assumed depletion rate associated with the item. Generally, the replenish item types may correspond to item types that are likely to be running low in the customer's inventory.

In step 2131, the system selects the top ranked item in the list of ranked items 2122 that matches replenishment item type indicated in the list of replenishment item types 2123. For example, if the list of replenishment item types indicate that the customer is likely to be running low of eggs, the system may select the top ranked brand and type (e.g. free range, organic, cage free, etc.) of eggs in the list of the ranked items 2122.

In step 2132, the system determines whether adding the item selected in step 2131 to the list of selected items 2141 would exceed a limit. In some embodiments, limits considered in step 2132 may comprise one or more delivery container size limit, delivery container weight limit, receiving container size limit, and total order cost limit. If the considered limits would not be exceeded with the selected item, the item is added to the list of selected items 2141 to be delivered to the customer. At step 2142, the system determines whether a limit is reached after the addition of the item selected in step 2131. If a limit is reached or nearly reached (e.g. 90%, 95%, etc.), the process ends in step 2160. If a limit is not yet reached, in step 2143, the system determines whether more replenishment item types are still unfilled. If at least one replenishment item type has not been processed, the system selects the next replenishment item type in step 2133 and returns to step 2131 to add more items to the list of selected items 2141. Step 2131-2132 may be repeated until all replenishment item types are processed or when a limit is reached. If all replenish item types are filled, in step 2143, the system then moves to step 2151 to consider the next item on the ranked item list that not of a replenishment item type.

In step 2151, the system moves onto the next highest ranked item on the list of ranked items 2122. In some embodiments, for each item the list, the system may determine whether the item is of a type that has been recently purchased in step 2152. For example, if the customer had recently (e.g. within the last month, 2 months, etc.) purchased a large package of paper towels, the system would not add another package of paper towels to the list of selected items. In some embodiments, step 2152 may be based on the customer's purchase history stored in the purchase history database 2113. In some embodiments, the system may determine whether another item of the same type has already been included in the list of the selected items 2141 in step 2153. For example, if a laundry detergent is already on the list of selected items 2141, the system may not add another laundry detergent to the list. In some embodiments, the system may determine whether adding the item to the list of selected items 2141 would exceed a limit. In some embodiments, limits considered in step 2154 may comprise one or more of delivery container size limit, delivery container weight limit, receiving container size limit, and total order cost limit. If the considered limits would not be exceeded with the addition of the selected item, the item is added to the list of selected items 2141 to be delivered to the customer. At step 2142, the system determines whether a limit is reached after the addition of the item selected in step 2131, if a limit is reached to close to be reached, the process ends in step 2160. If the limit has not been reached, the system may repeat steps 2151-2154 to add more items to the list of selected items 2141 until the limit is reached.

In some embodiments, after step 2160, the list of selected items 2141 generated through this process may be forwarded to a shipment preparation system to pack and deliver the items on the list of selected items 2141 to the customer.

The process shown in FIG. 21 is shown as an example only. The system may include fewer or more considerations shown in FIG. 21 without departing from the spirit of the present disclosure. For example, the system may skip step 2153 and send two or more of the same type of items for the customer to select from. In another example, the system may further prevent any item that has recently been returned by the customer from being added to the list of selected items 2141. In some embodiments, the system may not utilize a list of replenishment item types 2123 and skips one or more of steps 2131, 2132, 2143, and 2133. In some embodiments, the system may determine a replenishment score based on how likely the customer may need to replenish each item and select items based on a combination of each item's alignment score and replenishment score.

In one embodiment, a system for managing deliveries comprises a customer profile database, a product database, and a control circuit coupled to the customer profile database and the product database. The control circuit being configured to retrieve at least one customer value vector associated with a customer from the customer profile database storing customer partiality vectors for a plurality of customers, the customer partiality vectors comprise customer value vectors, compare the at least one customer value vector with vectorized product characterizations of a plurality of items in the product database to select one or more items compatible with the at least one customer value vector to deliver to the customer, and instruct the one or more items to be delivered to the customer.

In one embodiment, a method for managing deliveries comprises retrieving, with a control circuit, at least one customer value vector associated with a customer from a customer profile database storing customer partiality vectors for a plurality of customers, the customer partiality vectors comprise customer value vectors, comparing, with the control circuit, the at least one customer value vector with vectorized product characterizations of a plurality of items stored in a product database to select one or more items compatible with the at least one customer value vector to the customer, and instructing, with the control circuit, the one or more items to be delivered to the customer.

In one embodiments, an apparatus for managing deliveries comprises a non-transitory storage medium storing a set of computer readable instructions, and a control circuit configured to execute the set of computer readable instructions which causes to the control circuit to: retrieve at least one customer value vector associated with a customer from a customer profile database storing customer partiality vectors for a plurality of customers, the customer partiality vectors comprise customer value vectors, compare the at least one customer value vector with vectorized product characterizations of a plurality of items stored in a product database to select one or more items compatible with the at least one customer value vector to deliver to the customer, and instruct the one or more items to be delivered to the customer.

In some embodiments, a system for managing deliveries comprises a customer profile database, a product database, and a control circuit coupled to the customer profile database and the product database. The control circuit being configured to retrieve at least one customer value vector associated with a customer from the customer profile database storing customer partiality vectors for a plurality of customers, the customer partiality vectors comprise customer value vectors, compare the at least one customer value vector with vectorized product characterizations of a plurality of items in the product database to select one or more items compatible with the at least one customer value vector to deliver to the customer; and instruct the one or more items to be delivered to the customer.

In some embodiments, the customer partiality vectors each represents at least one of a person's values, preferences, affinities, and aspirations. In some embodiments, the customer value vectors each comprises a magnitude that corresponds to the customer's belief in good that comes from an order associated with that value. In some embodiments, the customer partiality vectors comprise partiality vectors determined from a purchase history of the customer. In some embodiments, the purchase history includes purchase associated with one or more categories of products and the one or more items are associated with at least one category of products not previously purchased by the customer as recorded in the purchase history. In some embodiments, the control circuit is further configured to: receive a return request from the customer after the delivery of the one or more items and update the customer partiality vectors of the customer based on the return request. In some embodiments, the one or more items comprise a product not previously purchased by the customer. In some embodiments, the one or more items comprise a replenishment product selected based on a purchase history of the customer. In some embodiments, the control circuit is further configured to process a charge for the one or more items after the customer accepts the delivery of the one or more items. In some embodiments, the one or more items are delivered as part of a reoccurring delivery subscription service.

In some embodiments, a method for managing deliveries comprises retrieving, with a control circuit, at least one customer value vector associated with a customer from a customer profile database storing customer partiality vectors for a plurality of customers, the customer partiality vectors comprise customer value vectors, comparing, with the control circuit, the at least one customer value vector with vectorized product characterizations of a plurality of items stored in a product database to select one or more items compatible with the at least one customer value vector to the customer, and instructing, with the control circuit, the one or more items to be delivered to the customer.

In some embodiments, the customer partiality vectors each represents at least one of a person's values, preferences, affinities, and aspirations. In some embodiments, the customer value vectors each comprises a magnitude that corresponds to the customer's belief in good that comes from an order associated with that value. In some embodiments, the customer partiality vectors comprise partiality vectors determined from a purchase history of the customer. In some embodiments, the purchase history includes purchase associated with one or more categories of products and the one or more items are associated with at least one category of products not previously purchased by the customer as recorded in the purchase history. In some embodiments, the method further comprises receiving a return request from the customer after the delivery of the one or more items and updating the customer partiality vectors of the customer based on the return request. In some embodiments, wherein the one or more items comprise a product not previously purchased by the customer. In some embodiments, wherein the one or more items comprise a replenishment product selected based on a purchase history of the customer. In some embodiments, the method further comprises processing a charge for the one or more items after the customer accepts the delivery of the one or more items. In some embodiments, the one or more items are delivered as part of a reoccurring delivery subscription service.

In some embodiments, an apparatus for managing deliveries comprises a non-transitory storage medium storing a set of computer readable instructions and a control circuit configured to execute the set of computer readable instructions which causes to the control circuit to: retrieve at least one customer value vector associated with a customer from a customer profile database storing customer partiality vectors for a plurality of customers, the customer partiality vectors comprise customer value vectors, compare the at least one customer value vector with vectorized product characterizations of a plurality of items stored in a product database to select one or more items compatible with the at least one customer value vector to deliver to the customer, and instruct the one or more items to be delivered to the customer.

In some embodiments, apparatuses and methods are provided herein useful to selecting customized care packages for customers. In some embodiments, there is provided a system including: a first database with categories of possible events and trip destinations and candidate items for a care package corresponding to each category of possible events or trip destinations; a second database with customer data; and a control circuit configured to: receive data about a customer and an upcoming actual event or trip destination; match the data regarding the actual upcoming event or trip destination with one of the categories of possible events and trip destinations in the first database; determine the corresponding plurality of candidate items for the care package; compare the corresponding plurality of candidate items for the care package with the customer data; and select final items from the plurality of candidate items for the care package based on the customer data.

Generally speaking, pursuant to various embodiments, systems, apparatuses and methods are provided herein useful to selecting care packages to address possible needs of customers. In some embodiments, there is provided a system including: a first database containing: a predetermined plurality of categories of possible events and trip destination locations; and a predetermined plurality of candidate items for a care package corresponding to each category of possible events or trip destination locations; a second database containing data about a plurality of customers; a control circuit configured to: receive data identifying a customer and data regarding an upcoming actual event or trip destination location of the customer; access the data in the first database; match the data received regarding the actual upcoming event or trip destination location with one of the categories of possible events and trip destination locations in the first database; determine the corresponding plurality of candidate items for the care package in the first database; access the customer data in the second database; compare the corresponding plurality of candidate items for the care package in the first database with the customer data in the second database; and select final items from the plurality of candidate items for the care package based on the customer data in the second database.

In some form, the control circuit may be configured to receive input directly from the customer identifying an upcoming actual event or trip destination location of the customer. Further, the control circuit may be configured to receive the data identifying the customer and data regarding an upcoming actual event or trip destination location of the customer from a social media source communicatively coupled to the control circuit. In addition, the control circuit may be configured to receive the data identifying the customer and data regarding an upcoming actual event or trip destination location of the customer from a customer's calendar software communicatively coupled to the control circuit.

In some forms, the control circuit may be configured to: access partiality information for the customer and to use that partiality information to form corresponding partiality vectors for the customer wherein the partiality vector has a magnitude that corresponds to a magnitude of the customer's belief in an amount of good that comes from an order associated with that partiality. Also, the control circuit may be further configured to: form counterpart candidate item vectors for each care package in the first database wherein the counterpart vectors have a magnitude that represents the degree to which each of the candidate items pursues a corresponding partiality. Moreover, the control circuit may be further configured to: use the partiality vectors and the candidate item vectors to identify candidate items that accord with a given customer's own partialities. In addition, the control circuit may be further configured to: identify the final items for the customized care package from the candidate items that have been identified to accord with the given customer's own partialities.

In some forms, the control circuit may be configured to: instruct collection of the final items for the customized care package; and instruct shipment of the customized care package to one of the trip destination location or the customer's residence. Further, the control circuit may be configured to instruct shipment of the customized care package without prior request for the customized care package by the customer. Also, the control circuit may be configured to: determine a shopping facility close to the actual trip destination location or customer's residence; and instruct shipment of the customized care package to the shopping facility if it is not accepted by the customer.

In another form, there is provided a method for selecting customized care packages for customers including: storing, in a first database, a predetermined plurality of categories of possible events and trip destination locations in a first database; and storing, in the first database, a predetermined plurality of candidate items for a care package corresponding to each category of possible events or trip destination locations; storing, in a second database, data about a plurality of customers; and by a control circuit: receiving data identifying a customer and data regarding an upcoming actual event or trip destination location of the customer; accessing the data in the first database; matching the data received regarding the actual upcoming event or trip destination location with one of the categories of possible events and trip destination locations in the first database; determining the corresponding plurality of candidate items for the care package in the first database; accessing the customer data in the second database; comparing the corresponding plurality of candidate items for the care package in the first database with the customer data in the second database; and selecting final items from the plurality of candidate items for the care package based on the customer data in the second database.

In another form, there is provided a system for selecting customized care packages for customers traveling to trip destination locations including: a database containing: a predetermined plurality of categories of possible trip destination locations; and a predetermined plurality of items for a care package corresponding to each category of trip destination location; a control circuit configured to: receive data identifying a customer and data regarding an upcoming actual trip of the customer and the actual trip destination location; match the data received regarding the actual upcoming trip destination location with one of the categories of possible trip destination locations in the database; determine the corresponding plurality of items for the care package in the database; instruct collection of the items for the customized care package; instruct shipment of the customized care package to the actual trip destination location without prior request for the customized care package by the customer.

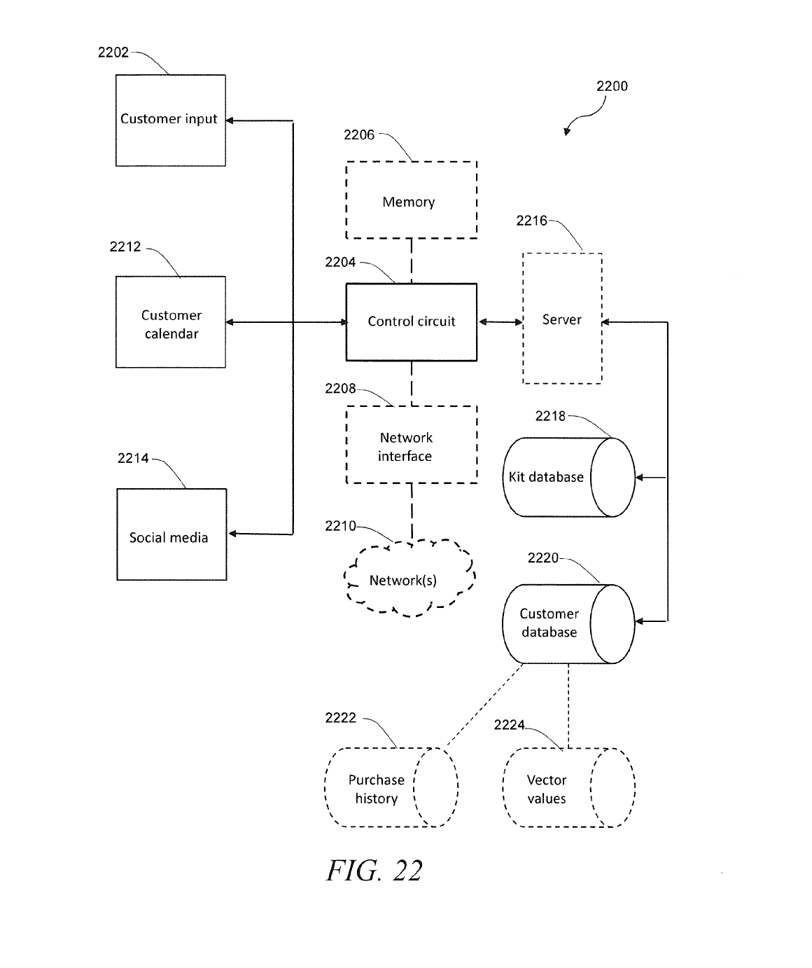

Referring to FIG. 22, there is shown a block diagram illustrating a system 2200 with various components. The system 2200 generally receives an input identifying a customer and an upcoming event (such as a social event, like a birthday party) or trip destination of the customer. After the system 2200 receives this input, the system 2200 accesses a kit database for possible candidate items for a care package for this sort of event or trip destination. The system 2200 then accesses a customer database for customer preferences to customize the care package for this particular customer.

As can be seen from FIG. 22, the input information of customer identification and an upcoming event/trip destination may be collected in various ways. In one form, the system 2200 may receive this information by direct customer input 2202. In other words, the system 2200 may include a control circuit 2204 that is configured to receive input 2202 directly from the customer identifying an upcoming actual event or trip destination location of the customer. The customer may directly approach a retailer to request a customized care package. For example, a customer may access a retailer's website or application and provide information that identifies the customer and that provides information about the upcoming event or trip destination. In one form, the customer may access the website or application, indicate that the customer needs a care package, and input a description of the event or trip destination (or the customer may be prompted to select the event or trip destination from possible categories in a drop down menu).

As described herein, the language “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 2204 may be configured (for example, by using corresponding programming stored in a memory as will be well understood by those skilled in the art) to carry out one or more of the steps, actions, and/or functions described herein.

As shown in FIG. 22, the control circuit 2204 may be coupled to a memory 2206, a network interface 2208, and network(s) 2210. The memory 2206 can, for example, store non-transitorily computer instructions that cause the control circuit 2204 to operate as described herein, when the instructions are executed, as is well known in the art. Further, the network interface 2208 may enable the control circuit 2204 to communicate with other elements (both internal and external to the system 2200). These network interface 2208 is well understood in the art. The network interface 2208 can communicatively couple the control circuit 2204 to whatever network or networks 2210 may be appropriate for the circumstances.

It is also contemplated that the information about upcoming events or trip destinations may be collected in other ways. For example, in one form, the control circuit 2204 may be configured to receive data identifying the customer and data regarding an upcoming actual event or trip destination location of the customer from a customer's calendar software 2212 communicatively coupled to the control circuit 2204. In this form, it is generally contemplated that the customer has “opted in” to a care package program and has made this calendar 2212 generally available to the control circuit 2204. For example, the system 2200 may access a customer's calendar and determine that the customer is or will be traveling. In some forms, the system 2200 may perform a key word search for possible upcoming events and trips.

It is also contemplated that a customer may not desire to provide information about upcoming events and trip destinations on a piecemeal basis, which raises the possibility that the customer may forget to plan for a particular event and trip destination ahead of time. The customer may want to avoid placing the burden on himself to remember every individual upcoming event and trip destination and may instead want to apply a more automated approach. Accordingly, the customer may prefer that the calendar 2212 be searched periodically (such as at the beginning of every month) for any and all upcoming events and trip destinations for which a customized care package may be appropriate.

In one form, it is contemplated that the control circuit 2204 may prompt the customer once it identifies an upcoming event or trip destination. For example, the control circuit 2204 may ask the customer whether a care package should be prepared for every upcoming event or trip destination on the calendar 2212 and await confirmation from the customer. It is also contemplated that the customer may prefer a more automated approach in which a customized care package is selected and assembled without awaiting confirmation. For example, the control circuit 2204 may be configured to provide notice to the customer when the customized care package is ready to be shipped or is being shipped. Alternatively, as described further below, the control circuit 2204 may be configured not to provide any advance notice but instead to allow the customer to accept or reject the customized care package after the package has been delivered to the final location.

In another form, it is also contemplated that the information regarding an upcoming event or trip destination may be collected from social media. In other words, the control circuit 2204 may be configured to receive data regarding an upcoming actual event or trip destination location of the customer from a social media source 2214 communicatively coupled to the control circuit 2204. For example, the customer may provide such information publicly on social media 2214, such as Facebook, YouTube, Instagram, Twitter, Tumblr, Flickr, or the like. It is also contemplated that the information may be collected from any of various types of devices, including, for example, desktop computers, laptops, tablets, mobile devices (smartphones, smart watches, etc.).

Once the input information is collected regarding a customer and an upcoming event/trip destination, the control circuit 2204 may access database(s), such as via a server 2216, to select items for a customized care package. One database is a kit database 2218. This kit database 2218 generally contains several categories of possible events and trip destination locations and candidate items for a care package corresponding to each category of possible events or trip destination locations. It is generally contemplated that possible categories of events and trip destinations in the kit database 2218 will be considered and determined, and then, appropriate possible items for each category will be considered and determined. For example, if the trip destination is Hawaii, the candidate items may include swimwear, sunscreen, etc., while in contrast, if the trip destination is Alaska, the candidate items may include parkas, boots, etc.

In one form, it is contemplated that the system 2200 may interact with the customer regarding the candidate items and collect customer preference information directly from the customer. For example, the control circuit 2204 may recommend a “toiletries” package when a customer is travelling (the control circuit 2204 may find hotel reservations on a smartphone and suggest a toiletries package be delivered to the hotel) and await confirmation from the customer. As a further example, the control circuit 2204 may detect or be informed that the customer is attending a birthday party for a child. The control circuit 2204 can then recommend a birthday party package for an X year old (boy/girl). For example, the control circuit 2204 may monitor sales for this age group and suggest three popular gifts within a price range. Further, the control circuit 2204 may itemize the products in the collection, and the customer can alter one or more products (remove, add, replace).

In one form, the control circuit 2204 may also access a customer database 2220. It is generally contemplated that the customer database 2220 may include customer preference information that will enable a customer-specific selection of items for the customized care package from the universe of candidate items. The control circuit 2204 may be configured to use this customer-specific information to narrow the candidate items down to a specific number of final items for the customized care package.

This customer preference information may be maintained in several ways. For example, in one form, the customer preference information may constitute the purchase history of the customer, and the customer database 2220 may be in the form of a purchase history database 2222. As an example, the control circuit 2204 may be configured to only select items from the candidate items that were previously purchased by the customer or are of a type that were previously purchased by the customer. In another form, it is contemplated that the customer preference information may constitute value vectors showing customer preferences and their relative magnitude, and the customer database 2220 may be in the form of a value vector database 2224. The concept of value vectors is addressed in greater detail further below.

It is then contemplated that the control circuit 2204 may use customer data to select the customized care package. More specifically, the control circuit 2204 may be configured to: receive data from an input 2202, 2212, 2214 identifying the customer and data regarding the upcoming actual event or trip destination location of the customer; access the data in the kit database 2218; match the data received regarding the actual upcoming event or trip destination location with one of the categories of possible events and trip destination locations in the kit database 2218; determine the corresponding plurality of candidate items for the care package from the kit database 2218; access the customer database 2220/2222/2224; compare the corresponding plurality of candidate items for the care package from the kit database 2218 with the customer information from the customer database 2220/2222/2224; and select final items from the plurality of candidate items for the care package based on the customer data from the customer database 2220/2222/2224. As should evident, the databases described herein may be organized in any of various ways, such as, for example, to be arranged as a single comprehensive database or to be arranged by multiple databases and/or sub-databases. This disclosure is generally intended to encompass any of these various manners of organization of databases.

After selection of the final items, the control circuit 2204 may be configured to take additional action to deliver the care package to the customer. In one form, the control circuit 2204 may be configured to instruct collection of the final items for the customized care package and to instruct shipment of the customized care package to either the trip destination address or the customer's shipping address. In the case of a trip, the trip destination address may be included in the inputted information, or if not available, the control circuit 2204 may look up the destination address from a database. In the case of an event, the customer's shipping address may be accessible from a customer database (or other database) and is expected to generally include the customer's residence or business address.

It is also contemplated that the control circuit may be configured to instruct shipment of the customized care package without prior request for the customized care package by the customer. For example, the customer may be inclined to have an automated approach for delivering a care package without the customer being forced to recall to provide instructions for each upcoming event or trip in advance. It may defeat the purpose of the care package if the customer is forced to remember to provide instructions ahead of time for the events and trips. In one form, it is also contemplated that the control circuit 2204 may be configured to determine a shopping facility close to the actual trip destination location or customer's shipping address and to instruct shipment of the customized care package to the shopping facility if it is not accepted by the customer. For example, in the case of a retailer, the care package may be assembled and shipped by the retailer without prior notice to the customer with the understanding that, if the customer is not inclined to accept the care package, it will simply be returned to a local shopping facility of the retailer.

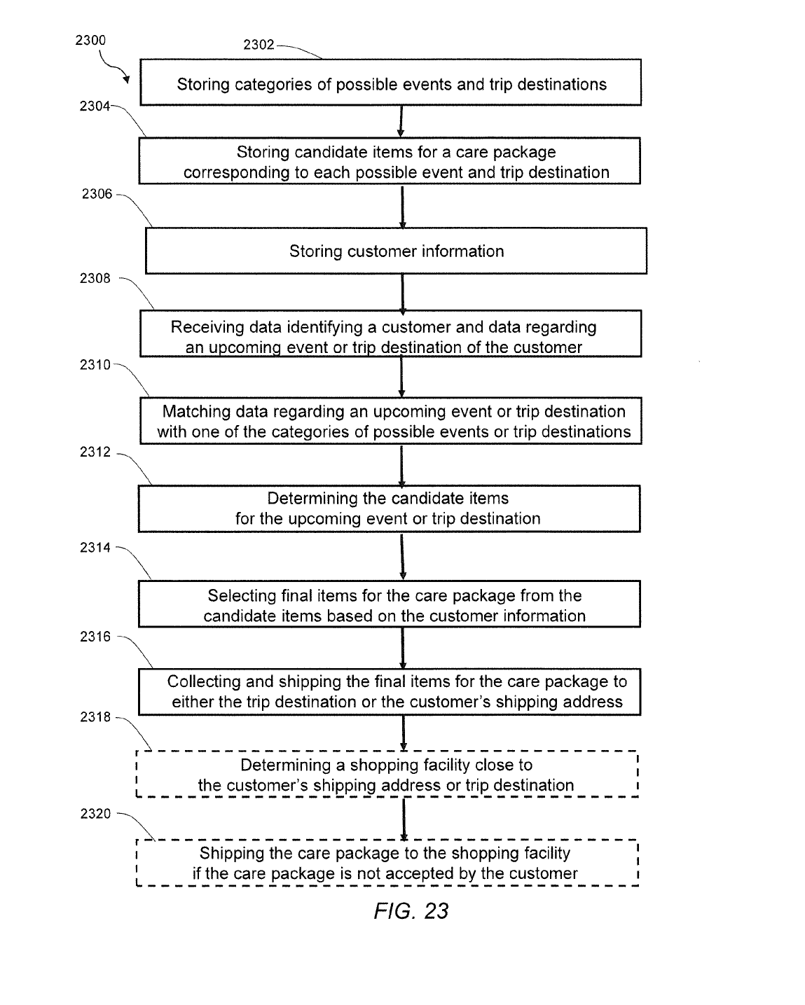

Referring to FIG. 23, there is shown a process 2300 that may use some of the components of system 2200. The process 2300 generally includes storing information about possible events and trip destinations and corresponding candidate items for a care package and includes storing customer preference information. The process 2300 receives data about an upcoming event or trip destination of a customer. The process 2300 then selects items for a care package from the candidate items based on customer preferences.

At block 2302, categories of possible events and trip destinations are stored. For example, possible events may include birthday parties (possible subdivided into separate age groups) and anniversaries. As another example, trip destinations may include trips to popular vacation destinations (such as Hawaii and other temperate resort locations) and business trips (such as annular trips to conventions held in specific cities). As should be evident, these categories may be stored in a kit database, and these categories may be continually and gradually updated with new possible events and trip destinations.

At block 2304, candidate items for a care package are stored. More specifically, candidate items are determined and stored for a care package for each possible event and trip destination, such as in a kit database. For example, the list of candidate items for a child's birthday party (such as toys, child's clothing, etc.) may differ significantly from the list of candidate items for a spouse's anniversary (such as flowers, jewelry, etc.). As another example, the list of candidate items for a trip to a resort location (such as sandals, towels, etc.) may differ significantly from the list of candidate items for a business trip (such as business attire, toiletries, etc.). As should be evident, the lists of candidate items may be continually and iteratively adjusted by replacing some of the candidate items with other items that are determined to be a better fit for the particular event or trip destination.

At block 2306, customer information is stored, which may take various forms. In one form, the customer information may simply constitute purchase history showing past items purchased by the customer. This form of customer information may be used to determine specific items desired by the customer or a specific category of item. For example, if the upcoming event is an anniversary, this purchase history may indicate roses (as a specific item) or flowers (as a specific category of item). In another form, the customer information may be in the form of customer value vector information, which may include information regarding a customer's world values and the magnitude of these values. This value vector approach is described in more detail further below. As should be evident, this customer information will likely be continually updated with new data regarding the customer.

At block 2308, information regarding an actual upcoming event or trip of the customer is received. As described above with respect to system 2200, this information may be of various types and may be received in various ways. In one way, the information may be provided directly by the customer, such as by accessing a retailer's website or application and indicated interest in a care package. In another way, the information may be collected from a customer's electronic calendar, which has been made available by the customer. In yet another way, the customer may include this information in the customer's social media, and the information may be collected from the social media. These examples are not limiting, and it is contemplated that this information can be provided in other ways.

At block 2310, the data regarding an actual upcoming event or trip destination of the customer is matched with the categories of events or trip destinations, such as in a kit database. In other words, the database may be searched to determine a close match or correspondence between one of the categories in the database and the data from the customer. At block 2312, once a category is selected, the candidate items are determined from that category of events and trip destinations. These candidate items may constitute the universe of items from which the actual items will be determined.

At block 2314, the final items for the care package are selected and determined. These final items are determined based on the customer preference information. For example, it may be determined that the final items will be the candidate items for which there is a purchase history. Under another approach, each of the candidate items may be a general category of items, and the actual final item in each category may be determined based on the customer's value vectors. For example, the general category of item may be handbags, and the specific type of handbag selected may be a biodegradable handbag based on the customer's high value vector for environmentally friendly items. In addition, the candidate items may be reduced to a lesser number of final items, and some of the candidate items may be eliminated entirely.

At block 2316, the final items for the care package are collected and shipped to an appropriate address. For example, for events, the final items may be shipped to a preferred customer address, such as the customer's residence or business address. It is contemplated that this address information may be accessible in a customer database including past purchases or, if necessary, may be determined from publicly available databases containing such information. For trip destinations, it is contemplated that the destination address may be accessible from the input (i.e., provided directly by the customer at a website or application, available from the customer's electronic calendar, or available from social media) or that the destination address (such as a hotel address) may be determined from publicly available databases.

It is also contemplated that the care package may be sent by a retailer with confirmation by the customer or without notice and/or confirmation by the customer. Blocks 2318 and 2320 address a situation where the customer may have not have advance notice of the care package, and the care package may need to be returned to a convenient location. At block 2318, a shopping facility close to the customer's shipping address or trip destination is determined. At block 2320, the care package may be shipped to the nearby shopping facility if the care package is not accepted by the customer. For example, if the customer cancels the trip, the care package may arrive at a destination hotel, will not be accepted by the customer, and can be shipped to the nearby shopping facility.

In one form, as mentioned above, this disclosure makes use of the concept of “value vectors.” This disclosure generally seeks to match candidate items for a care package with customer-specific values, affinities, aspirations, and preferences, which are measured in terms of “value vectors.” It is generally contemplated that there are multiple possible final items for a care package. This disclosure seeks to match possible final items form the candidate items with a specific customer's values, affinities, aspirations, and preferences. If this match can be made, appealing final items should be sent in the care package to the customer. As used herein, the term “customer” includes both customers who make an actual purchase and to potential customers who may or may not make a purchase. “Value vectors” are described in more detail as follows.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

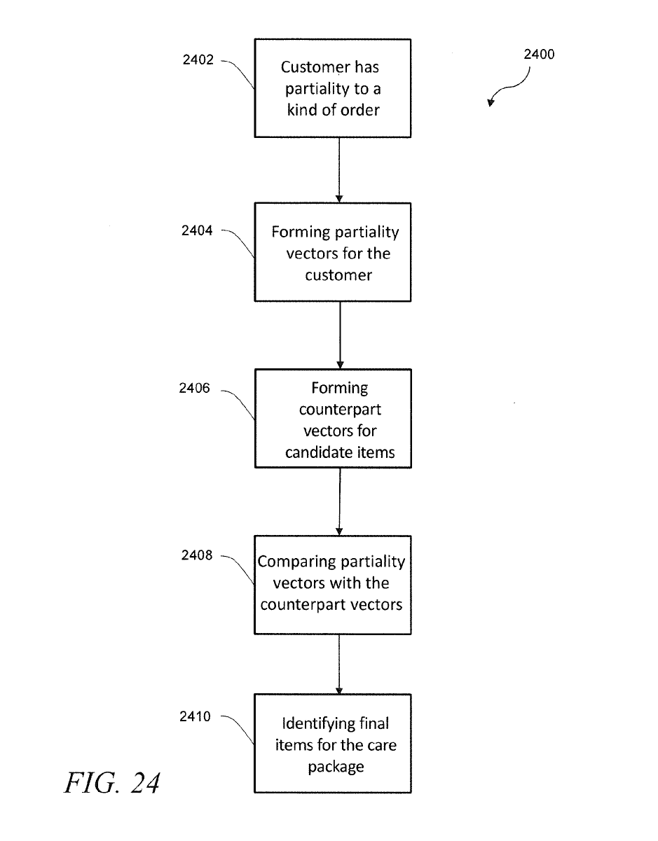

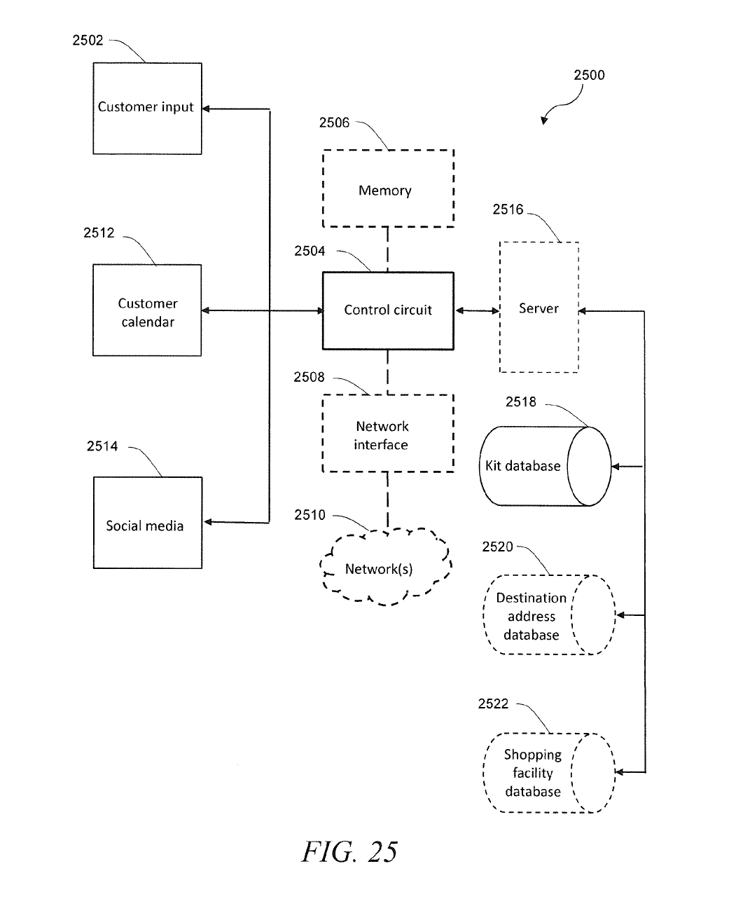

Applying the value vector approach to selecting the care package, the final items for the care package may be selected based on customer values, affinities, aspirations, and preferences. Referring to FIG. 24, there is shown a process 2400 (following up on the value vector approach described above) that illustrates selection of the final items based on a value vector approach. At block 2402, it is shown that the customer has a partiality to a certain kind of order. At block 2404, this partiality information may be accessed and user to form corresponding partiality vectors for the customer wherein the partiality vector has a magnitude that corresponds to a magnitude of the customer's belief in an amount of good that comes from an order associated with that partiality. At block 2406, counterpart candidate item vectors for each care package can be formed wherein the counterpart vectors have a magnitude that represents the degree to which each of the candidate items pursues a corresponding partiality. At block 2408, the partiality vectors for the customer and the candidate item vectors may be used and compared to identify candidate items that accord with a given customer's own partialities. At block 2410, the final items for the customized care package from the candidate items that have been identified to accord with the given customer's own partialities. This process 2400 may be incorporated into system 2200 and process 2300 described above.

Referring to FIG. 25, there is shown a system 2500 for selecting a care package for a trip destination that may not involve customer preference information. This system 2500 is similar to system 2200 in some ways, such as with respect to potential sources of information about the upcoming trip and a kit database. However, the system 2500 generally involve care packages that are specially selected for each trip destination that may not be further modified based on customer-specific information. These care packages may be delivered to a customer without request by the customer and may be returned to a local shopping facility if not accepted by the customer.

As shown in FIG. 25, it is generally contemplated that the system 2500 will receive information about an upcoming trip and trip destination in any of various ways, including, without limitation, by direct customer input 2502, via an electronic customer calendar 2512, and through various social media 2514. Further, it is contemplated that the system 2500 includes a control circuit 2504 that may be operatively coupled to a memory 2506, a network interface 2508, and network(s) 2510. In addition, it is contemplated that the control circuit may have access, such as via a server 2516, to a kit database 2518. The kit database 2518 contains categories of possible trip destinations and items for a care package corresponding to each category of trip destinations. As addressed above, the kit database 2518 may be continually updated with additional possible trip destinations and the care package for each trip destination may be updated as a “better fit” is determined for that specific destination.

However, it is generally contemplated that the care package for a specific trip destination may not be further modified based on customer-specific information. Instead, the system 2500 may select and ship the same general items in a care package associated with a specific trip destination. In this form, it is contemplated that the customer may receive a care package appropriate to the destination without prior confirmation and may then accept the care package on an as-needed or as-desired basis. If the customer is not interested in the care package, it may be returned to a local shopping facility, such as of the retailer sending the care package.

The system 2500 may include a destination address database 2520. It is contemplated that the destination address may be obtained during the receipt of information regarding the upcoming trip. However, the destination address may not be available at this input of information. So, it is contemplated that the control circuit 2504 may then obtain the destination address in various ways. One way of obtaining the information may be by accessing a destination address database 2520, such as a publicly available address look-up database. The system 2500 may also include a shopping facility database 2522. This database 2522 may include a list of the shopping facilities of a retailer, and the control circuit 2504 may use this data to determine a shopping facility close to the destination address.

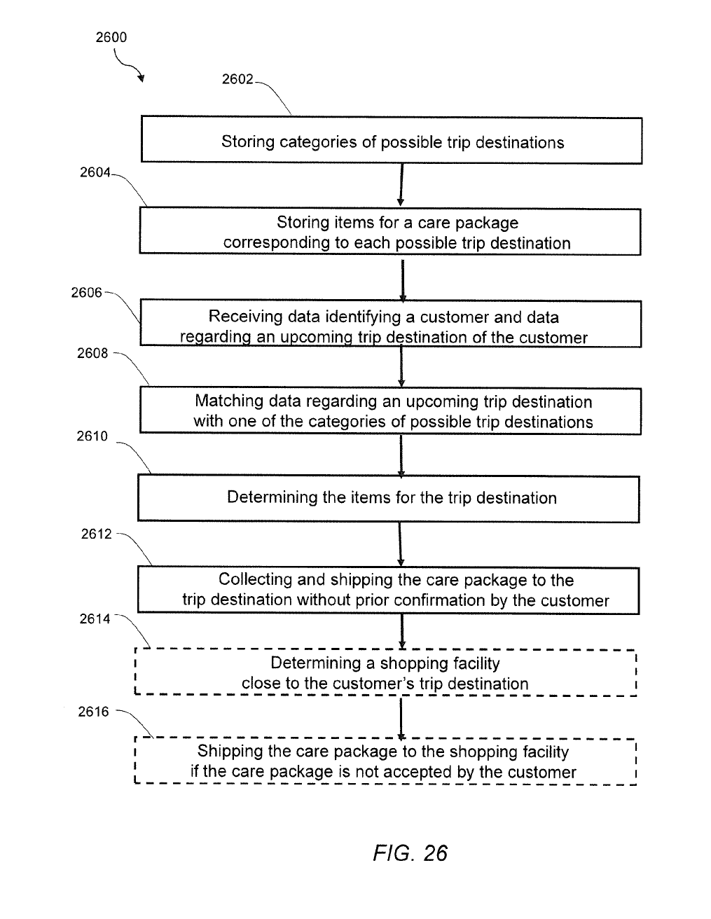

Referring to FIG. 26, there is shown a process 2600 for selecting and delivering a care package to a trip destination that may use components of system 2500. At block 2602, categories of possible trip destinations are stored, and in one form, the trip destinations may be grouped by such categories as city, island, resort name, etc., or some combination thereof. At block 2604, items for a care package corresponding to each possible category of trip destination are stored. In other words, a care package may be created for each trip destination. It is contemplated that the care packages for customers traveling to the same trip destination may be uniform. It is generally contemplated that the storing of this trip destination and care package information is continual and gradual and may involve periodic updates.

At block 2606, data may be received identifying a particular customer and regarding an upcoming trip of the customer. The data may be received in various ways, as addressed above with respect to systems 2200 and 2500. At block 2608, the received data identifying an upcoming trip of the customer is matched with one of the categories of possible trip destinations that have been stored. At block 2610, the corresponding items for the care package for the matching possible trip destination is determined. These items will be the items that will be shipped to the customer in the care package.

At block 2612, the items in the care package are collected and shipped to the trip destination. In this process 2600, it is generally contemplated that the items may be delivered to the customer without prior confirmation by the customer. In one form, it is contemplated that some individuals leading busy lives may not have sufficient time or inclination to fully prepare for a trip and may not pack or ship all of the items that may be needed or desired for a trip. Indeed, a customer may make an intentional decision not to pack and/or travel with some items. So, items may be provided to the customer at the destination address that may be needed by the customer, and following delivery, the customer may make a decision whether it makes sense for the customer to accept some or all of the items. If not accepted, at block 2614, a shopping facility close to the trip destination may be determined, and at block 2616, the care package (or some of the items therein) may be returned by shipping them to the local shopping facility.

In some embodiments, a system for selecting customized care packages for customers comprises a first database containing a predetermined plurality of categories of possible events and trip destination locations and a predetermined plurality of candidate items for a care package corresponding to each category of possible events or trip destination locations, a second database containing data about a plurality of customers, a control circuit configured to: receive data identifying a customer and data regarding an upcoming actual event or trip destination location of the customer, access the data in the first database, match the data received regarding the actual upcoming event or trip destination location with one of the categories of possible events and trip destination locations in the first database, determine the corresponding plurality of candidate items for the care package in the first database, access the customer data in the second database, compare the corresponding plurality of candidate items for the care package in the first database with the customer data in the second database, and select final items from the plurality of candidate items for the care package based on the customer data in the second database.

In some embodiments, the control circuit is configured to receive input directly from the customer identifying an upcoming actual event or trip destination location of the customer. In some embodiments, the control circuit is configured to receive the data identifying the customer and data regarding an upcoming actual event or trip destination location of the customer from a social media source communicatively coupled to the control circuit. In some embodiments, the control circuit is configured to receive the data identifying the customer and data regarding an upcoming actual event or trip destination location of the customer from a customer's calendar software communicatively coupled to the control circuit. In some embodiments, the control circuit is configured to access partiality information for the customer and to use that partiality information to form corresponding partiality vectors for the customer wherein the partiality vector has a magnitude that corresponds to a magnitude of the customer's belief in an amount of good that comes from an order associated with that partiality. In some embodiments, the control circuit is further configured to: form counterpart candidate item vectors for each care package in the first database wherein the counterpart vectors have a magnitude that represents the degree to which each of the candidate items pursues a corresponding partiality. In some embodiments, the control circuit is further configured to: use the partiality vectors and the candidate item vectors to identify candidate items that accord with a given customer's own partialities. In some embodiments, the control circuit is further configured to: identify the final items for the customized care package from the candidate items that have been identified to accord with the given customer's own partialities. In some embodiments, the control circuit is configured to: instruct collection of the final items for the customized care package; and instruct shipment of the customized care package to one of the trip destination location or the customer's shipping address. In some embodiments, wherein the control circuit is configured to instruct shipment of the customized care package without prior request for the customized care package by the customer. In some embodiments, the control circuit is configured to: determine a shopping facility close to the actual trip destination location or customer's residence; and instruct shipment of the customized care package to the shopping facility if it is not accepted by the customer.

In some embodiments, a method for selecting customized care packages for customers comprises storing, in a first database, a predetermined plurality of categories of possible events and trip destination locations in a first database and storing, in the first database, a predetermined plurality of candidate items for a care package corresponding to each category of possible events or trip destination locations, storing, in a second database, data about a plurality of customers, and by a control circuit: receiving data identifying a customer and data regarding an upcoming actual event or trip destination location of the customer, accessing the data in the first database, matching the data received regarding the actual upcoming event or trip destination location with one of the categories of possible events and trip destination locations in the first database, determining the corresponding plurality of candidate items for the care package in the first database, accessing the customer data in the second database, comparing the corresponding plurality of candidate items for the care package in the first database with the customer data in the second database, and selecting final items from the plurality of candidate items for the care package based on the customer data in the second database.

In some embodiments, the method further comprises, by the control circuit, receiving the data identifying the customer and data regarding an upcoming actual event or trip destination location of the customer from a social media source communicatively coupled to the control circuit. In some embodiments, the method further comprises, by the control circuit, receiving the data identifying the customer and data regarding an upcoming actual event or trip destination location of the customer based on input provided directly by the customer or from a customer's calendar software communicatively coupled to the control circuit. In some embodiments, the method further comprises, by the control circuit: accessing partiality information for the customer and using that partiality information to form corresponding partiality vectors for the customer wherein the partiality vector has a magnitude that corresponds to a magnitude of the customer's belief in an amount of good that comes from an order associated with that partiality. In some embodiments, the method further comprises, by the control circuit: forming counterpart candidate item vectors for each care package in the first database wherein the counterpart vectors have a magnitude that represents the degree to which each of the candidate items pursues a corresponding partiality. In some embodiments, the method further comprises, by the control circuit: using the partiality vectors and the candidate item vectors to identify candidate items that accord with a given customer's own partialities. In some embodiments, the method further comprises, by the control circuit: identifying the final items for the customized care package from the candidate items that have been identified to accord with the given customer's own partialities. In some embodiments, the method further comprises, collecting the final items for the customized care package; and shipping the customized care package to one of the actual trip destination location or the customer's shipping address. In some embodiments, the method further comprises, by the control circuit: determining a shopping facility close to the actual trip destination location or the customer's shipping address; and instructing shipment of the customized care package to the shopping facility if it is not accepted by the customer.

In some embodiments, a system for selecting customized care packages for customers traveling to trip destination locations comprises a database containing, a predetermined plurality of categories of possible trip destination locations, and a predetermined plurality of items for a care package corresponding to each category of trip destination location. A control circuit configured to receive data identifying a customer and data regarding an upcoming actual trip of the customer and the actual trip destination location, match the data received regarding the actual upcoming trip destination location with one of the categories of possible trip destination locations in the database, determine the corresponding plurality of items for the care package in the database, instruct collection of the items for the customized care package, instruct shipment of the customized care package to the actual trip destination location without prior request for the customized care package by the customer.

In some embodiments, the control circuit is configured to determine a shopping facility close to the actual trip destination location and instruct shipment of the customized care package to the shopping facility if it is not accepted by the customer within a predetermined amount of time.

Partiality vectors for a particular customer and vectorized characterizations of a plurality of products are employed by a control circuit to select a particular one of the plurality of products to ship to a particular customer. By one approach this selected product is shipped without the particular customer having ordered this product. By one approach the aforementioned selection is based upon a prediction that the particular customer will keep the selected product upon receipt thereof based upon those partiality vectors and vectorized characterizations notwithstanding that it may not be known whether the particular customer has ever previously made a purchasing decision regarding this particular product.

These teachings generally provide for using partiality vectors for a particular customer and vectorized characterizations of a plurality of products (both of which are explained in more detail herein) to select a particular one of the plurality of products to ship to a particular customer. By one approach this selected product is shipped without the particular customer having ordered this product. By one approach the aforementioned selection is based upon a prediction that the particular customer will keep the selected product upon receipt thereof based upon those partiality vectors and vectorized characterizations notwithstanding that it may not be known whether the particular customer has ever previously made a purchasing decision regarding this particular product.

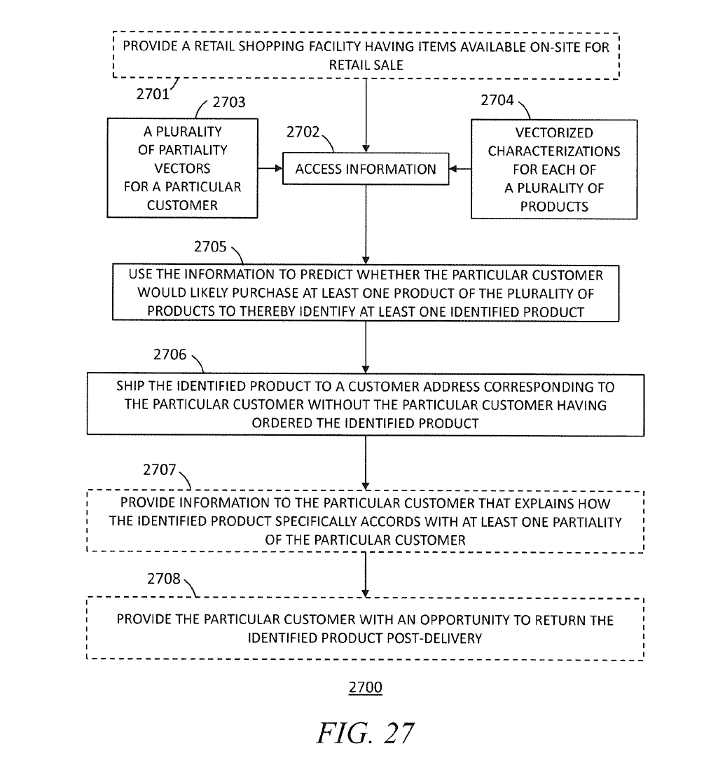

FIG. 27 presents another illustrative example. It will be understood that the depicted process 2700 is not intended to suggest any specific limitations or essential activities by way of its specificity.

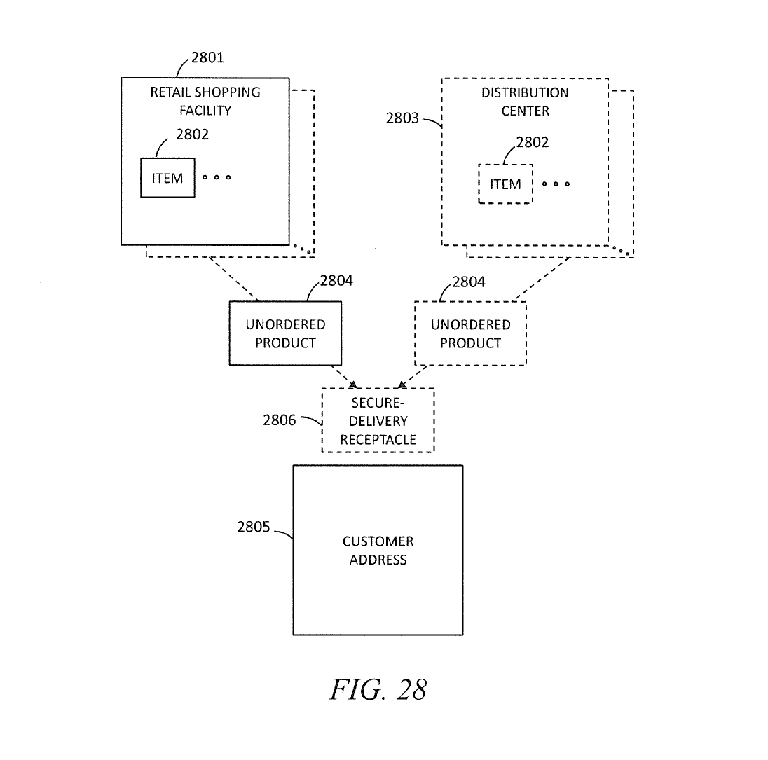

At optional block 2701 this process 2700 provides a retail shopping facility having items available on-site for retail sale. FIG. 28 provides an illustrative example of such a paradigm. In this example each retail shopping facility 2801 comprises a retail sales facility or any other type of bricks-and-mortar (i.e., physical) facility in which products are physically displayed and offered for sale to customers who physically visit the facility. The shopping facility may include one or more of sales floor areas, checkout locations (i.e., point of sale (POS) locations), customer service areas other than checkout locations (such as service areas to handle returns), parking locations, entrance and exit areas, stock room areas, stock receiving areas, hallway areas, common areas shared by merchants, and so on. The facility may be any size or format of facility, and may include products from one or more merchants. For example, a facility may be a single store operated by one merchant or may be a collection of stores covering multiple merchants such as a mall.

The retail shopping facility 2801 includes a plurality of different items 2802 that are physically available on-site (i.e., at the retail shopping facility 2801) for retail sale. The present teachings will accommodate essentially any kind of item including but not limited to durable goods, perishable items, and so forth. These items 2802 may or may not include their own packaging as desired.

The present teachings are not limited to application settings that include or otherwise take into account only a single retail shopping facility 2801. Instead, these teachings will readily accommodate application settings having a plurality of retail shopping facilities if desired. These various retail shopping facilities can be essentially identical to one another, somewhat similar in layout and offerings to one another, or very different from one another as desired. These various retail shopping facilities may be located relatively close to one another (for example, within five or ten miles of one another) or they may be located relatively distant from one another (for example, more than ten or twenty-five miles from one another) as appropriate to the application setting.

By one optional approach these teachings will also accommodate providing or otherwise accommodating one or more distribution centers 2803. As used herein the expression “distribution center” will be understood to refer to a physical facility (such as one or more buildings) where goods are received post-manufacture and are then further distributed to a plurality of retail shopping facilities. A distribution center is not itself a retail shopping facility and instead serves as part of the supply chain that supplies retail shopping facilities 2801 with products to be sold at retail. A distribution center can serve as a warehouse by temporarily storing received items pending the distribution of such items to retail shopping facilities 2801 but in many cases products will not be warehoused in a traditional sense and will instead be moved from a receiving area to a dispersal area to minimize the time during which the distribution center possesses such items. In a typical but not required application setting the distribution center and the corresponding retail shopping facilities 2801 will be co-owned/operated by a same enterprise.

In this illustrative example such a distribution center 2803 may also include items 2802 that are available for selection and shipping per the teachings presented herein.

At block 2702 of the process 2700 presented in FIG. 27, the aforementioned control circuit 1301 accesses information. This activity can comprise accessing the aforementioned memories 1303 and 1306 to thereby access information 2703 regarding a plurality of partiality vectors 1307 for a particular customer as well as information 2704 comprising the aforementioned vectorized characterizations 1304 for each of a plurality of products.

At block 2705 the control circuit 1301 uses the aforementioned information 2703 and 2704 to predict whether this particular customer would likely purchase and/or retain at least one product of the plurality of products to thereby identify at least one identified product. The strength of this prediction, in turn, can serve to identify one or more of the plurality of products to be shipped to the particular customer.

This process 2700 will accommodate any of a variety of strength thresholds in these regards. For example, in a particular application setting it may be sufficient that the particular customer is only 40% likely to keep a particular one of the plurality of products upon receipt thereof. By another approach it may be sufficient to determine that the particular customer is simply more likely than not to keep a particular one of the plurality of products upon receipt thereof. By yet another approach it may be useful to require that the particular customer be at least 80% likely to wish to keep a particular one of the plurality of products upon receipt thereof in order to select a particular one of the plurality of products to ship to the particular customer.

It will be understood that the aforementioned predictions can be readily based upon useful comparisons of the aforementioned partiality vectors 1307 and vectorized characterizations 1304 for the products. Accordingly, and generally stated, the control circuit 1301 can predict that a particular customer will be likely to be interested in a particular product that well accords with partialities that correspond to establishing, maintaining, and/or increasing a particular order that this customer covets in their life. That predicted interest, in turn, can serve as a significant and/or primary basis for predicting the aforementioned retention/purchase interest.

At block 2706 this process 2700 provides for shipping the identified product to a customer address (such as a residential address, a business address, or a private or postal-service post office box) corresponding to this particular customer without this particular customer having ordered the identified product. By one approach this activity comprises shipping this product without charge to the particular customer (for the product itself and/or for shipping/delivery costs). These teachings will accommodate sending only a single one of the identified product or a plurality of the identified product as desired.

FIG. 28 illustrates this activity. By one approach, the unordered product 2804 ships to the customer address 2805 from the aforementioned retail shopping facility 2801. By another approach, the unordered product 2804 is not presently available at retail shopping facility 2801 and ships instead from the aforementioned distribution center 2803. When the above-described activity results in identifying a plurality of items to ship to the particular customer, these teachings will accommodate shipping one or more of the identified items from a retail shopping facility 2801 and shipping one or more of the identified items from a distribution center 2803. These teachings will accommodate other approaches in these regards as well. For example, the identified item may be shipped directly from a third-party manufacturer at the behest of the enterprise that operates the retail shopping facility 2801.

To be clear, this process 2700 provides for shipping a product having a physical form and real-world value to a customer as an unsolicited gift and without the customer having ordered this particular item. By utilizing the aforementioned information 2703 and 2704, these teachings can select an item to send to a customer in this way notwithstanding that it may not be known if this particular customer has ever previously made a purchasing decision (either for or against) regarding such a product.

These teachings are highly flexible in these regards. By one approach, for example, the identified product constitutes the only product included in this particular shipment. By another approach, the identified product may be included with other items that this particular customer previously ordered. When the foregoing steps result in identifying a plurality of different products to send to this particular customer, these various products can be shipped simultaneously or at different times or with different expected delivery dates as desired.

The identified product can be delivered using any of a variety of shipping services and paradigms. Examples in these regards include but are not limited to third-party professional delivery services (such as the United States Postal Service, FedEx, or UPS), equipment and/or personnel belonging to the enterprise shipping the product to this customer, ad hoc services such as Uber or Lyft, and so forth. Part or all of the delivery chain may include terrestrial and/or airborne vehicles that may be partially or fully-autonomous as desired.

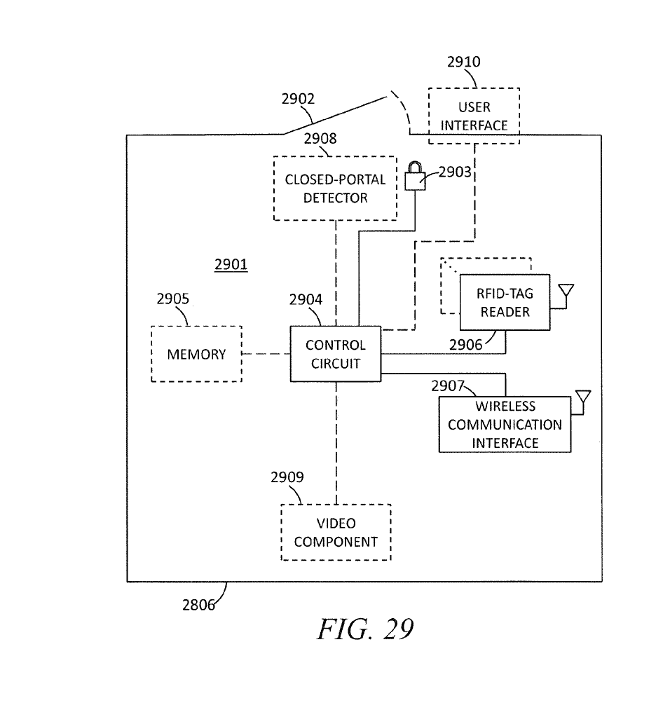

By one approach, shipment of the identified product to the customer address optionally comprises placing the identified product in a secure-delivery receptacle 2806 that corresponds to the customer address. FIG. 29 provides an illustrative example in these regards.

In this example the secure-delivery receptacle 2806 includes at least one delivered-package vault 2901 having at least one selectively-lockable access portal 2902. The delivered-package vault 2901 can assume any of a wide variety of form factors including any of a variety of differently-proportioned and differently-sized rectangles. By way of example and without intending any limitations in these regards, FIG. 29 illustrates a delivered-package vault 2901 having a rectangular (in this case, square) shape.

Similarly, the delivered-package vault 2901 can be comprised of any of a variety of materials include various metals, impact-resistant plastics, and so forth. The particular shape, size, and material employed in a given application can vary depending upon the needs and requirements of that application setting.

By one approach (and as shown in the illustrative example presented in FIG. 29) the selectively-lockable access portal 2902 comprises one or more doors that are pivotally secured to a front (or side or top) panel of the delivered-package vault 2901 and that is of sufficient size to cover an opening through that panel that is itself of sufficient size to permit ready access to the interior of the delivered-package vault 2901 to thereby facilitate the placement of delivered packages therein and the subsequent removal of such packages by the recipient.

A locking mechanism 2903 of choice permits this door to be selectively locked and unlocked by, for example, a control circuit 2904 to which the locking mechanism 2903 is operably coupled or to which the locking mechanism 2903 is otherwise remotely responsive. A variety of known locking mechanisms are known in the art that will suffice in these regards including, for example, locking mechanisms that employ an electrically-controlled latch.

The aforementioned control circuit 2904 can again comprise a fixed-purpose hard-wired platform or can comprise a partially or wholly programmable platform. These architectural options are well known and understood in the art and require no further description here. This control circuit 2904 is configured (for example, by using corresponding programming as will be well understood by those skilled in the art) to carry out one or more of the steps, actions, and/or functions described herein.

By one approach the control circuit 2904 operably couples to an optional memory 2905. This memory 2905 may be integral to the control circuit 2904 or can be physically discrete (in whole or in part) from the control circuit 2904 as desired. This memory 2905 can also be local with respect to the control circuit 2904 (where, for example, both share a common circuit board, chassis, power supply, and/or housing) or can be partially or wholly remote with respect to the control circuit 2904. This memory 2905 can serve, for example, to non-transitorily store the computer instructions that, when executed by the control circuit 2904, cause the control circuit 2904 to behave as described herein.

The secure-delivery receptacle 2806 in this example also includes one or more scanning devices such as one or more optical-code readers or, as shown, one or more RFID-tag readers 2906 that also operably couple to the control circuit 2904. Such RFID-tag readers 2906 are known in the art and serve to read RFID tags. These so-called tags often assume the form factor of a label or a literal “tag” but are also sometimes integrated with a host article and/or its packaging. RFID tags typically comprise an integrated circuit and one or more antennas. The integrated circuit typically carries out a variety of functions including modulating and demodulating radio frequency signals, data storage, and data processing. Some integrated circuits are active or self-powered (in whole or in part) while others are passive, being completely dependent upon an external power source (such as received power from the RFID tag reader) to support their occasional functionality.

By one approach the RFID-tag reader 2906 is located and configured to reliably read RFID tags that are disposed within the delivered-package vault 2901. By one approach this RFID-tag reader 2906 is configured to read RFID tags that provide unique corresponding identification numbers. The Electronic Product Code (EPC) as managed by EPCGlobal, Inc. represents one example in these regards. EPC-based RFID tags each have an utterly-unique serial number (within the EPC system) to thereby uniquely identify each tag and, by association, each item associated on a one-for-one basis with such tags. (The corresponding document entitled EPC Radio-Frequency Identity Protocols Class-1 Generation-2 UHF RFID Protocol for Communications at 2860 MHz-960 MHz Version 1.0.9 (often referred to as “EPC GEN2”) is hereby fully incorporated herein by this reference.)

For many application settings it is useful for the control circuit 2904 to have communicative connectivity that enables communications with remotely-located entities (such as delivery services, shipping entities, recipients, and so forth). If desired a non-wireless approach will serve in these regards (such as any of a variety of electrical or optical conductors that are known in the art). As illustrated in the present example a wireless communication interface 2907 of choice that operably couples to the control circuit 2904 serves in these regards. Any of a variety of short-range, medium-range, and long-range systems will suffice in these regards including, for example, any of a variety of wireless telephony systems.

By one optional approach the secure-delivery receptacle 2806 further includes a closed-portal detector 2908 that serves to detect when the selectively-lockable access portal 2902 is closed (or, conversely, opened). This closed-portal detector 2908 operably couples to the control circuit 2904 and hence serves to inform the latter as regards the opened/closed state of the selectively-lockable access portal 2902.

By one approach these teachings will further accommodate an optional video component 2909 configured to, for example, capture images of optical codes (such as Universal Product Codes (UPC's) or other bar or two-dimensional optical codes known in the art) that are disposed on packages placed inside the delivered-package vault 2901. Various video components are known in the art and the present teachings are not particularly sensitive to the selection of any particular approach.

By another optional approach, in combination with or in lieu of the foregoing optional approaches, the secure-delivery receptacle 2806 can include a user interface 2910. Such an interface can serve to permit, for example, the authorized recipient to enter a particular code to unlock the portal and thereby gain access to delivered items. Such an interface can comprise, for example, a physical keypad and/or a touch-screen display by which the user can read or otherwise perceive displayed content and enter their own text and otherwise select from amongst displayed operational options.

At optional block 2707 of the process 2700 shown in FIG. 27, shipment of the identified product to the customer address can be supplemented by providing information to the particular customer that explains how the identified product specifically accords with at least one partiality of the particular customer. For example, the customer may be provided with information that explains how the identified product specifically serves a particular value held by this customer.

The provided information may comprise text and/or non-textual graphic content as desired. The provided information may be included, in whole or in part, with the shipped product. By one approach, the provided information may include an Internet address such as a Uniform Resource Locator (URL) that leads the customer to a public or personalized webpage that presents the above-described explanation. By another approach the provided information may be presented as hardcopy included with the shipped product and/or that is printed or otherwise placed on the shipping packaging for the identified product. By yet another approach, this information may be provided to the above-described secure-delivery receptacle 2806 (via, for example, the above-described wireless communication interface 2907) and displayed on the above-described user interface 2910.

At optional block 2708, this process 2700 will also optionally accommodate providing the particular customer with an opportunity to return the identified product post-delivery. This capability can be useful even though the identified product has been provided to the customer without cost since the customer may not in fact wish to have the product and may not wish to be burdened with otherwise forwarding or disposing of the item.

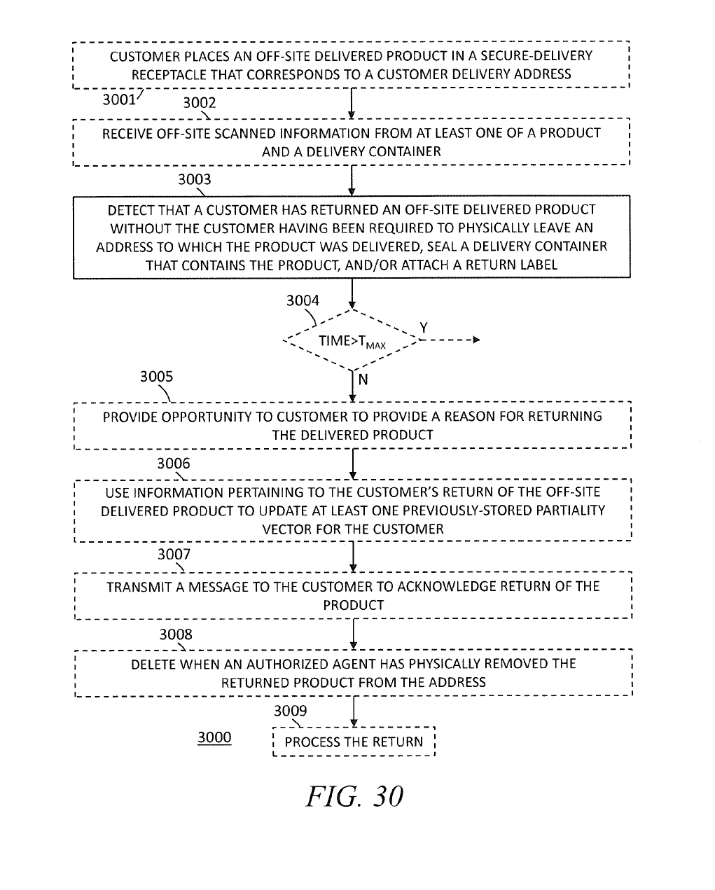

FIG. 30 presents an illustrative process 3000 in these regards. This particular example presumes that the product was originally delivered to the customer via a corresponding secure-delivery receptacle 2806 as described above. That said, it will be understood that many of the activities presented in this process 3000 are not dependent upon the availability of a secure-delivery receptacle 2806.

At optional block 3001 the recipient customer places an off-site delivered product (where “off-site” will be understood to refer to a product that was not delivered to the customer “on-site” at the aforementioned retail shopping facility 2801) (for example, the unordered product 2804 described above) into their corresponding secure-delivery receptacle 2806 (i.e., the secure-delivery receptacle 2806 that corresponds to their physical delivery address, which is likely the same address at which they first received the off-site delivered product).

In this illustrative example it is presumed that this customer places the off-site delivered product into the secure-delivery receptacle 2806 while the product is still within the original shipping packaging (such as a cardboard box, thick padded envelope, or the like). These teachings will accommodate that original shipping packaging being either unopened or in an opened state. If the customer has opened the original shipping packaging (for example, to facilitate viewing and/or otherwise evaluating the off-site delivered product), these teachings will accommodate the customer re-sealing the original shipping packaging before placing the packaging in the secure-delivery receptacle 2806 or not as desired.

If desired, these teachings will also accommodate not requiring the customer to place any additional content on the exterior of the packaging when placing the latter in the secure-delivery receptacle 2806. For example, these teachings will accommodate, if desired, not requiring the customer to place a return label on the packaging and/or not requiring the customer to write anything on the packaging or occlude any previous content on the packaging (such as a previously-placed optical code such as a bar code).

At optional block 3002 of this process 3000 these teachings provide for receiving (for example, at the aforementioned control circuit 1301) off-site scanned information from at least one of the product itself and/or the delivery container for that product (i.e., the original manufacturer's container (such as a box) for the product and/or shipping packaging). (Again, “off-site” refers to the information being scanned other than on-site at the retail shopping facility 2801.)

By one approach, the aforementioned RFID-tag reader 2906 reads one or more RFID tags that are located on or in the product and/or the delivery container for that product, in which case the scanned information is gleaned, at least in part, from such RFID tags. By another approach, in lieu of the foregoing or in combination therewith, the aforementioned video component 2909 or other mechanism reads one or more optical codes that are located on the product and/or the delivery container for that product, in which case the scanned information is gleaned, at least in part, from such optical codes. In both of these cases the off-site scanned information is sourced by the secure-delivery receptacle 2806 into which the product has been returned by the customer subsequent to the customer having removed that product from the secure-delivery receptacle 2806.

The substantive content of the scanned information can vary with the needs and/or capabilities of a given application setting. Examples of scanned information include but are not limited to information that categorically identifies the product (such as, for example, a Stock Keeping Unit (SKU) number), information that specifically identifies the product (such as, for example, an EPC identification number), information about the customer, information about the delivery (such as the time of delivery), information about the delivery address, and so forth.

In any event, at block 3003 the control circuit 1301 detects that a customer has returned the off-site delivered product (for example, in this case, by placing the product into the secure-delivery receptacle 2806). By one approach, this “return” is detected without the customer having been required to physically leave the address to which the product was delivered, or to seal the delivery container that contains the product (even when the packaging has been opened by the customer), and/or to attach a return label to the product/packaging. So configured, the return process/mechanism for the customer is virtually frictionless and hence the customer experiences virtually no burden (in terms of time, effort, or thought/attention) to return an unsolicited product that they did not order and do not wish to retain.

In some cases the facilitating enterprise may wish to impose one or more time restrictions with respect to the foregoing. To support such activity and as illustrated at optional decision block 3004, this process 3000 will support determining whether the product was returned to the secure-delivery receptacle 2806 within a specified amount of time (T_{MAX}) following when the customer removed the product from the secure-delivery receptacle 2806. This amount of time may comprise only one or a few hours or one or a few days as desired. The amount of time allowed may vary dynamically with the customer and/or the delivered product or such other considerations as may be relevant to the enterprise.

When the specified threshold amount of time has expired, these teachings will support taking whatever action may be appropriate in the eyes of the implementing enterprise. By one approach, for example, the enterprise may require that the customer take additional steps and/or provide additional information before processing the return of the product.

At optional block 3005 this process 3000 provides an opportunity to the customer to provide a reason (or reasons) for returning the delivered product. This opportunity can comprise, for example, sending the customer a text message or an email message to which the customer can reply with the salient reason(s). By another approach, if desired, the opportunity can be presented using the aforementioned user interface 2910 on the secure-delivery receptacle 2806 itself (by, for example, presenting the opportunity in the form of one or more questions on a touch screen display).

In any event, at optional block 3006 this process 3000 provides for using information pertaining to the customer's return of this product to update at least one previously-stored partiality vector 1307 for this customer. By one approach, the mere fact that the customer returned a product that the control circuit 1301 had predicted would be welcomed by the customer may be taken into account and used to update the relevant partiality vector(s) 1307. In many cases it may not be appropriate to presume that a particular partiality vector 1307 does not in fact apply to this customer simply because the customer returned this product. Instead, it may be appropriate to consider, in light of the return, whether one or more other partialities are in play that outweighed the known partiality vector(s) in the mind of the customer. It may also be appropriate to consider modifying the magnitude of one or more partiality vectors for this customer to attempt to better align with the customer's actual partialities as evinced through their return of this (and possibly other) products.

Converse actions may also be appropriate. For example, upon determining that a customer has not returned an unordered product as described herein, it may be appropriate to update their partiality vectors 1307 by adjusting the magnitude of known partiality vectors 1307 and/or by adding an additional one or more partiality vectors 1307 to their profile to better/best accord with their having kept the unsolicited item.

Per optional block 3007 this process 3000 permits the control circuit 1301 to transmit a message to the customer to acknowledge return of the product. This transmission can comprise use of any of a variety of messaging techniques including but not limited to text messages, email, in-app alerts, and messages provided via the user interface 2910 for the secure-delivery receptacle 2806.

By one approach, and as illustrated at optional block 3008, the control circuit 1301 can detect when an authorized agent (such as an employee of the corresponding enterprise or a third-party contractor for an authorized delivery service) physically removes the returned product from the address (in this case, from the secure-delivery receptacle 2806). This detection can be based, for example, upon input from the aforementioned RFID-tag reader 2906, video component 2909, or otherwise as desired.

And at optional block 3009 the control circuit 1301 can respond to detecting the customer's physical return of the product to the secure-delivery receptacle 2806 by processing the transactional return of the product. In the case where the customer is returning a product that they in fact paid for, this processing can include effecting a refund or credit for all or part of the amount paid.

So configured, these teachings provide various ways to leverage and/or update partiality vectors for various customers in ways that are well-designed to often please the customer without a concurrent risk of greatly bothering or annoying the customer. These teachings are also highly flexible in practice and will accommodate a wide variety of modifications and/or additions.

As one example in these regards, these teachings will accommodate assessing partiality vectors for a sub-population of customers that includes the aforementioned particular customer. This sub-population may consist, for example, of people within a shopping area that corresponds to the aforementioned retail shopping facility 2801. This shopping area may be defined in terms of distance (for example, within a predetermined distance of the retail shopping facility 2801) and/or the yet some other appropriate mechanism (for example, based upon residential subdivisions, municipal boundaries, and so forth). In this case, using the information to predict whether the particular customer would likely purchase/retain a particular product can include, at least in part, identifying which products accord to at least a predetermined level to a particular partiality vector (or vectors) for the people in this sub-population. A particular identified product can then be shipped as described above to appropriate corresponding persons in this sub-population.

In some embodiments, an apparatus comprises a memory having stored therein: information including a plurality of partiality vectors for a particular customer and vectorized characterizations for each of a plurality of products, wherein each of the vectorized characterizations indicates a measure regarding an extent to which a corresponding one of the products accords with a corresponding one of the plurality of partiality vectors, and a control circuit operably coupled to the memory and configured to select a particular one of the plurality of products to ship to the particular customer as a function, at least in part, of the partiality vectors and the vectorized characterizations.

In some embodiments, at least some of the partiality vectors are based, at least in part, upon prior purchases made by the customer. In some embodiments, the partiality vectors include at least one partiality vector that is knowingly based upon at least one value of the particular customer. In some embodiments, the control circuit is further configured to facilitate shipping the particular one of the plurality of products to the particular customer without the particular customer having ordered the particular one of the plurality of products. In some embodiments, the control circuit is further configured to predict that the particular customer will keep the particular one of the plurality of products upon receipt thereof based upon the partiality vectors and the vectorized characterizations notwithstanding that it is not known if the particular customer has ever previously made a purchasing decision regarding the particular one of the plurality of products. In some embodiments, the control circuit is further configured to facilitate shipping the particular one of the plurality of products to the particular customer without charge to the particular customer.

In some embodiments, a method comprises providing a retail shopping facility having items available on-site for retail sale, accessing information including a plurality of partiality vectors for a particular customer and vectorized characterizations for each of a plurality of products, wherein each of the vectorized characterizations indicates a measure regarding an extent to which a corresponding one of the products accords with a corresponding one of the plurality of partiality vectors, using the information to predict whether the particular customer would likely purchase at least one product of the plurality of products to thereby identify at least one identified product, wherein the identified product may or may not comprise one of the items available at the retail shopping facility, and shipping the identified product to a customer address corresponding to the particular customer without the particular customer having ordered the identified product.

In some embodiments, the partiality vectors include at least one partiality vector that is knowingly based upon at least one value of the particular customer. In some embodiments, shipping the identified product to the customer address comprises shipping the identified product to the customer address without charge to the particular customer. In some embodiments, shipping the identified product to the customer address further comprises providing information to the particular customer that explains how the identified product specifically accords with at least one partiality of the particular customer. In some embodiments, providing information to the particular customer that explains how the identified product specifically accords with at least one partiality of the particular customer comprises providing information to the particular customer that explains how the identified product specifically serves a particular value. In some embodiments, shipping the identified product to the customer address comprises placing the identified product in a secure-delivery receptacle that corresponds to the customer address. In some embodiments, the method further comprises providing the particular customer with an opportunity to return the identified product post-delivery. In some embodiments, providing the particular customer with the opportunity to return the identified product post-delivery includes providing the particular customer with an opportunity to indicate at least one reason for returning the identified product. In some embodiments, the method further comprises using the at least one reason to update the plurality of partiality vectors for the particular customer. In some embodiments, accessing the information including the plurality of partiality vectors for a particular customer comprises accessing information including a plurality of partiality vectors corresponding to a sub-population that includes the particular customer. In some embodiments, the sub-population consists of people within a shopping area that corresponds to the retail shopping facility. In some embodiments, using the information to predict whether the particular customer would likely purchase at least one product of the plurality of products comprises, at least in part, identifying which products accord to at least a predetermined level to a particular partiality vector.

Generally speaking, pursuant to various embodiments, systems, apparatuses, and methods are provided herein useful for selecting a good or a service for a customer based on the customer's partialities. In some embodiments an apparatus includes a value vector database and a control circuit. The value vector database includes partialities of a customer. The control circuit is in communication with the value vector database and is configured to identify a customer, determine, based on the value vector database, one or more partialities of the customer, select, based on the one or more partialities of the customer, one or more of a good and a service for the customer, and cause provision of the one or more of a good and a service to the customer.

As previously discussed, some customers may find shopping to be time-consuming, frustrating, and/or overly burdensome. Described herein are systems, methods, and apparatuses that can reduce some or all of these drawbacks to shopping. To achieve this goal, in some embodiments, a system selects goods and or/services for a customer based on the customer's partialities. For example, the system can aggregate data about customers and over time determine customer partialities based on this data. The partialities reflect what a customer values. Customers will exert effort to order their lives to conform to these values. The system can select goods and/or service for customers based on these partialities. Goods and/or services can allow a customer to order his or her life to conform to that value while exerting less effort (i.e., goods and/or services allow customers to exert less effort while still achieving the order they desire). The goods and/or services present value propositions. A value proposition is the promise that using a good and/or service will help a customer order his or her life more easily (e.g., by requiring the exertion of less effort). In some embodiments, the system matches the order enabled by the goods and/or services with a customer's desire to order his or her life. As one example, if a customer values protecting the environment and maintaining organization in his or her life, the system can select a desk organizer that is made by a manufacturer committed to sustainability. As another example, if the customer values social relationships and kindness to animals, the system can select an expert to plan a party for the customer that includes vegan products. After selecting a good and/or service, the system can cause provision of the good and/or service to the customer. For example, the system can cause the good to be shipped to the customer without the customer purchasing the good and/or without the customer's knowledge. The customer can return goods or decline services that he or she does not want. In such embodiments, when a customer returns a good or declines a service, the customer's action provides feedback to the system to greater intuit the customer's partialities.

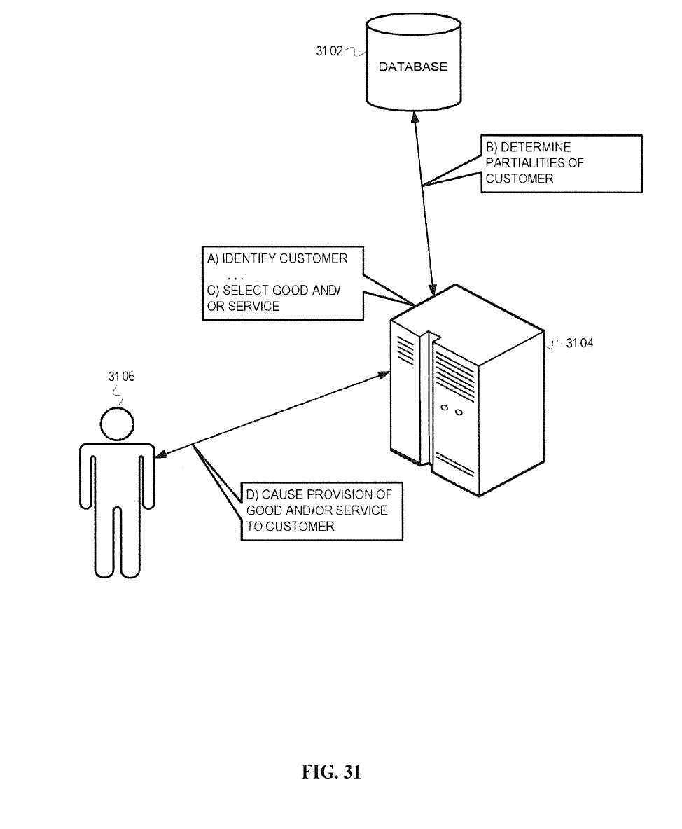

The discussion of FIG. 31 refers generally to partialities and value propositions. The discussion of FIGS. 1-17 provides more detailed information with regard to partialities and value propositions.

FIG. 31 is a diagram depicting example operations for selecting a good or a service for a customer 3106 based on the customer's 3106 partialities, according to some embodiments. The example operations include operations between a computer system 3104, a database 3102, and a customer 3106. FIG. 31 depicts operations at stages A-D. The stages are examples and are not necessarily discrete occurrences over time (e.g., the operations of different stages may overlap). Additionally, FIG. 31 is an overview of example operations.

At stage A, the computer system identifies the customer 3106. The computer system 3104 can identify the customer 3106 based on goods or services available. For example, when a new good or service becomes available, the computer system 3104 can identify the customer 3106 based on a determination that the customer 3106 is likely to approve of the good or service. Additionally, or alternatively, the computer system 3104 can identify the customer 3106 based on the customer's 3106 shopping history. For example, if the customer 3106 has not purchased anything recently, the computer system 3104 can identify the customer. Additionally, the identification of the customer can include identifying an account associated with the customer. The account can include information about the customer, such as the customer's name, address, billing information, preferences, purchase history, etc. In this regard, identifying the customer can both selecting a customer as well as determining information specific to the customer.

At stage B, the computer system 3104 determines partialities of the customer 3106. In some embodiments, the computer system 3104 accesses the database 3102 (e.g., a value vector database) to determine partialities of the customer 3106. The database 3102 can include an array or other data structure including customers and each customer's associated partialities. In addition to including partialities associated with each customer, the database 3102 can include other information about the customers, such as each customer's likes and dislikes, shipping and billing information, purchase history, demographics, etc.

At stage C, the computer system 3104 selects goods and/or services for the customer 3106 based on the customer's 3106 partialities. In some embodiments, each good and service includes value propositions. The value propositions associated with each of the goods and services can be stored in the database 3102 (or any other suitable location). The computer system 3104 selects goods and/or services for the customer 3106 by comparing the customer's 3106 partialities with the value propositions of the goods and/or services. In some embodiments, the computer system 3104 can also select the goods and/or services based on the customer's shopping history. For example, if the customer 3106 typically buys a new pair of shoes at the beginning of each month, the computer system 3104 can select a pair of shoes that have value propositions that align with the customer's 3106 partialities at the beginning of the month.

At stage D, the computer system 3104 causes provision of the selected goods and/or services to the customer 3106. For example, the computer system 3104 can cause goods to be shipped to the customer or an indication of a selected service to be presented to the customer (e.g., via mail, email, text message, etc.). In some embodiments, the computer system 3104 causes provision of the goods and/or services without approval of the customer 3106. For example, the computer system 3104 may not alert the customer that the goods are being shipped to the customer 3106 or that and order has been created for the customer 3106. As another example, the computer system 3104 may alert the customer 3106 of the shipment without first receiving input from the customer 3106 to cause the shipment. In such embodiments, the customer 3106 may be able to return any goods, or decline any services, provisioned by the computer system 3104. This can provide valuable feedback that can enhance the information known about the customer 3106. Additionally, the customer 3106 may only be charged for goods or services which he or she accepts.

While FIG. 31 and the related text provide some background information for selecting a good or a service for a customer based on the customer's partialities, FIGS. 1-17 and the related text provide greater information about partialities and value vectors.

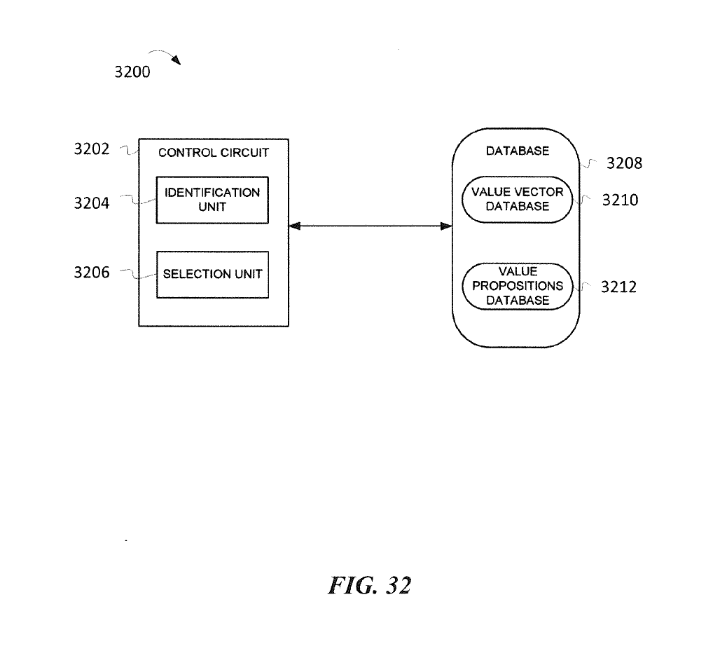

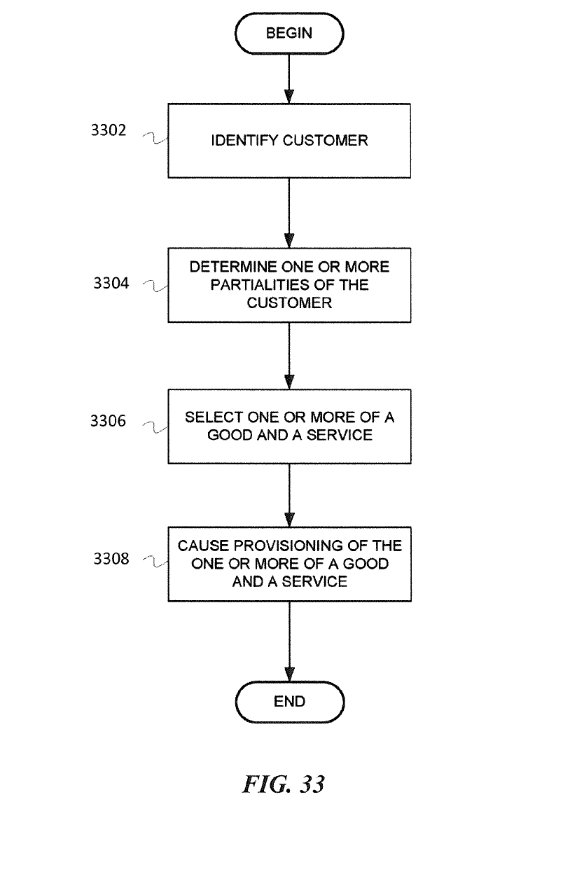

While FIGS. 1-17 and the related text provide greater information about partialities and value vectors, FIGS. 32-33 and the related text provide additional information about selecting goods and services for a customer based on the customer's partialities.

FIG. 32 is block diagram of an example system 3200 for selecting a good or a service for a customer based on the customer's partialities, according to some embodiments. The system 3200 includes a control circuit 3202 and a database 3208. It should be noted that the system 3200 depicted in FIG. 32 is a simplified system and that implementation can include different, or additional, hardware and/or software.

The control circuit 3202 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 302 is configured (for example, by using corresponding programming as will be well understood by those skilled in the art) to carry out one or more of the steps, actions, and/or functions described herein.

By one optional approach the control circuit 3202 operably couples to a memory. The memory may be integral to the control circuit 3202 or can be physically discrete (in whole or in part) from the control circuit 3202 as desired. This memory can also be local with respect to the control circuit 3202 (where, for example, both share a common circuit board, chassis, power supply, and/or housing) or can be partially or wholly remote with respect to the control circuit 3202 (where, for example, the memory is physically located in another facility, metropolitan area, or even country as compared to the control circuit 3202).

This memory can serve, for example, to non-transitorily store the computer instructions that, when executed by the control circuit 3202, cause the control circuit 3202 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit 3202 includes an identification unit 3204 and a selection unit 3206. The identification unit 3204 identifies customers. For example, the identification unit 3204 can identify a customer based on currently available goods or services, promotional or sale goods or services, past goods and/or services purchased by the customer, etc. As a specific example, the identification unit 3204 can identify a customer that is currently shopping (e.g., online).

The selection unit 3206 selects a good and/or service for the customer. The selection unit 3206 selects goods and/or services for the customer based on the customer's partialities and the value propositions of the goods and services. In some embodiments, the selection unit 3206 accesses the database 3208 to select goods and/or services for the customer. As depicted in FIG. 32, the database 3208 includes two individual databases: a value vector database 3210 and a value propositions database 3212. The value vector database 3210 includes partialities that are associated with the customers. The value propositions database 3212 includes value propositions associated with each of the goods and services. While FIG. 32 depicts the value vector database 3210 and the value propositions database 3212 as separate, in some embodiments the contents of both the value vector database 3210 and the value propositions database 3212 can be contained in a single database.

While FIG. 32 and the related text describe an example system for selecting goods and/or services based on a customer's partialities, FIG. 33 and the related text describe example operations for selecting goods and/or services based on a customer's partialities.

FIG. 33 is a flow diagram depicting example operations for selecting a good or service for a customer based on the customer's partialities. The flow begins at block 3302.

At block 3302, a customer is identified. For example, a control circuit identifies the customer. The customer can be identified, for example, based on goods and/or services available, partialities of the customer, value propositions of the goods and/or services, etc. Additionally, the identification of the customer can include identifying an account associated with the customer. The account can include information about the customer, such as the customer's name, address, billing information, preferences, purchase history, etc. In this regard, identifying the customer can both selecting a customer as well as determining information specific to the customer. The flow continues at block 3304.

At block 3304, one or more partialities of the customer are determined. For example, the control circuit can determine one or more partialities of the customer. In some embodiments, a customer's partialities are indicated in a user account associated with the customer. In such embodiments, the partialities, as well as the user accounts, can be stored in a database. The control circuit can determine one or more partialities of the customer based on the identifying the customer and the database. For example, the control circuit can access the database to retrieve the partialities of the customer. The flow continues at block 3306.

At block 3306, one or more of a good and a service are selected. For example, a good(s) can be selected, a service(s) can be selected, or a good(s) and a service(s) can be selected. In some embodiments, the control circuit can select the good and/or service. The control circuit can select the good and/or service based on the customer's partialities. Additionally, the selection can be based on value propositions of the good and/or service as well. For example, the control circuit can select a good and/or service having value propositions that correspond with the customer's partialities. The control circuit can also use data and information, in addition to the partialities and value propositions, to select goods and/or services for the customer. For example, the control circuit can select a good and/or service based on the customer's shopping history. In some embodiments, the control circuit can select goods and/or services from categories. For example, goods and services can be categorized by type, price point, retailer, quantity, availability, etc. The control circuit can select goods and/or services from categories from which the customer has previously made purchase. For example, if the customer has previously purchased computer products, the control circuit can select other computer products for the customer. Additionally, or alternatively, the control circuit can select goods and/or services from categories from which the customer has not previously made a purchase. For example, the customer may frequently buy clothing and partialities for the customer have been, at least partially, determined based on the clothing purchases. The control circuit could select dishes for the customer based on the partialities determined based on purchased of products from other categories (i.e., clothing). In some embodiments, the control circuit can select the goods and/or services without input from the customer. The flow continues at block 3308.

At block 3308, provisioning of the one or more of a good and a service is caused. For example, the control circuit can cause provisioning of the one or more of a good and a service. In some embodiments, the control circuit causes provisioning of the goods and/or services by arranging or instructing shipment of the goods and/or indications of the services to be presented. Additionally, or alternatively, the control circuit can cause provision of services by causing a notification (e.g., via mail, email, text message, etc.) to be transmitted to the customer. In some embodiments, the control circuit causes provisioning of the goods and/or services to the customer without prior approval form the customer. For example, the customer may not know that the goods and/or services have been selected for him or her or that the goods and/or services have been sent to him or her.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

Generally speaking, pursuant to various embodiments, systems, apparatuses, and methods are provided herein useful for selecting a good or a service for a customer based on the customer's partialities. In some embodiments an apparatus includes a value vector database and a control circuit. The value vector database includes partialities of a customer. The control circuit is in communication with the value vector database and is configured to identify a customer, determine, based on the value vector database, one or more partialities of the customer, select, based on the one or more partialities of the customer, one or more of a good and a service for the customer, and cause provision of the one or more of a good and a service to the customer.

Some embodiments include a method. The method can include identifying a customer, determining, based on a value vector database that includes partialities of the customer, one or more partialities for the customer, selecting, based on the one or more partialities of the customer, one or more of a good and a service for the customer, and causing provision of the one or more of a good and a service to the customer.

In some embodiments, an apparatus comprises a value vector database, wherein the value vector database includes partialities of a customer and a control circuit, the control circuit in communication with the value vector database and configured to: identify a customer, determine, based on the value vector database, one or more partialities of the customer, select, based on the one or more partialities of the customer, one or more of a good and a service for the customer, and cause provision of the one or more of a good and a service to the customer.

In some embodiments, wherein the value vector database includes value propositions of available goods and services. In some embodiments, the one or more of a good and a service are selected from the available goods and services based on the value propositions of the available goods and services. In some embodiments, the operation to cause provision of the one or more of a good and a service to the customer includes arranging shipment of the one or more of a good and a service to the customer. In some embodiments, the one or more of a good and a service includes services rendered by an expert. In some embodiments, the services rendered by an expert include one or more of event planning, product selection, product design, and design services. In some embodiments, the control circuit is further configured to receive feedback, wherein the feedback indicates that the customer one of returned and declined the one or more of a good and a service and update, in the value vectors database, the one or more partialities of the customer based on the feedback. In some embodiments, the partialities of the customer are determined based on previous purchases, wherein the previous purchases do not include goods and services from a category, and wherein the one or more of a good and a service is from the category. In some embodiments, the category includes one or more of a type of goods, a type of services, a price point, a retailer, and a quantity of a good. In some embodiments, the operation to cause provision of the one or more of a good and a service to the customer occurs without customer approval.

In some embodiments, a method comprises identifying a customer, determining, based on a value vector database that includes partialities of the customer, one or more partialities for the customer, selecting, based on the one or more partialities of the customer, one or more of a good and a service for the customer; and causing provision of the one or more of a good and a service to the customer.

In some embodiments, the value vector database includes value propositions of available goods and services. In some embodiments, the one or more of a good and a service are selected from the available goods and services based on the value propositions of the available goods and services. In some embodiments, the causing provision of the one or more of a good and a service to the customer includes arranging shipment of the one or more of a good and a service to the customer. In some embodiments, the one or more of a good and a service includes services rendered by an expert. In some embodiments, the services rendered by an expert include one or more of event planning, product selection, product design, and design services. In some embodiments, receiving feedback, wherein the feedback indicates that the customer one of returned and declined the one or more of a good and a service and updating, in the value vector database, the one or more partialities of the customer based on the feedback. In some embodiments, the partialities of the customer are determined based on previous purchases, wherein the previous purchases do not include goods and services from a category, and wherein the one or more of a good and a service is from the category. In some embodiments, the category includes one or more of a type of goods, a type of services, a price point, a retailer, and a quantity of a good. In some embodiments, the causing provision of the one or more of a good and a service to the customer occurs without customer approval.

This application is related to, and incorporates herein by reference in its entirety, each of the following U.S. provisional applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,804 filed Mar. 15, 2017; 62/471,830 filed Mar. 15, 2017; 62/479,525 filed Mar. 31, 2017; 62/480,733 filed Apr. 3, 2017; 62/482,863 filed Apr. 7, 2017; 62/482,855 filed Apr. 7, 2017; and 62/485,045 filed Apr. 13, 2017.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
a memory having stored therein:
information including a plurality of partiality vectors for a particular customer;
vectorized characterizations for each of a plurality of products, wherein each of the vectorized characterizations indicates a measure regarding an extent to which a corresponding one of the products accords with a corresponding one of the plurality of partiality vectors;
a control circuit operably coupled to the memory and configured to select at least one particular one of the plurality of products to present to the particular customer as a candidate for automatic periodic shipping as a function, at least in part, of the partiality vectors and the vectorized characterizations.

2. The apparatus of claim 1 wherein a least some of the partiality vectors are based, at least in part, upon prior purchases made by the customer.

3. The apparatus of claim 1 wherein the partiality vectors include at least one partiality vector that is knowingly based upon at least one value of the particular customer.

4. The apparatus of claim 3 wherein the at least one partiality vector that is knowingly based upon at least one value of the particular customer is not also based upon any prior purchase made by the customer.

5. The apparatus of claim 1 wherein the control circuit is further configured to:
select a particular one of the plurality of products to also ship to the particular customer without charge to the particular customer and without the particular customer having ordered the particular one of the plurality of products as a function, at least in part, of the partiality vectors and the vectorized characterizations.

6. The apparatus of claim 5 wherein the control circuit is further configured to:
predict that the particular customer will keep the particular one of the plurality of products upon receipt thereof based upon the partiality vectors and the vectorized characterizations notwithstanding that it is not known if the particular customer has ever previously made a purchasing decision regarding the particular one of the plurality of products.

7. A method comprising:
providing a retail shopping facility having items available on-site for retail sale;
accessing information including a plurality of partiality vectors for a particular customer and vectorized characterizations for each of a plurality of products, wherein each of the vectorized characterizations indicates a measure regarding an extent to which a corresponding one of the products accords with a corresponding one of the plurality of partiality vectors;
using the information to identify an identified product to present to the particular customer as a candidate for automatic periodic shipping, wherein the identified product may or may not comprise one of the items available at the retail shopping facility;
when the particular customer selects to receive the particular product via the automatic period shipping, thereafter shipping the identified product to a customer address corresponding to the particular customer on an automated periodic basis.

8. The method of claim 7 wherein the partiality vectors include at least one partiality vector that is knowingly based upon at least one value of the particular customer.

9. The method of claim 8 wherein the at least one partiality vector that is knowingly based upon at least one value of the particular customer is not also based upon any prior purchase made by the customer.

10. The method of claim 9 further comprising:
selecting a particular one of the plurality of products to also ship to the particular customer without charge to the particular customer and without the particular customer having ordered the particular one of the plurality of products as a function, at least in part, of the partiality vectors and the vectorized characterizations.

11. The method of claim 10 wherein shipping the particular one of the plurality of products to the customer address further comprises providing information to the particular customer that explains how the particular one of the plurality of products specifically accords with at least one partiality of the particular customer.

12. The method of claim 11 wherein providing information to the particular customer that explains how the particular one of the plurality of products specifically accords with at least one partiality of the particular customer comprises providing information to the particular customer that explains how the particular one of the plurality of products specifically serves a particular value.

13. The method of claim 7 further comprising:
providing the particular customer with an opportunity to return the identified product following an automated periodic shipment thereof.

14. The method of claim 13 wherein providing the particular customer with the opportunity to return the identified product following an automated periodic shipment thereof includes providing the particular customer with an opportunity to halt future automated periodic shipments of the identified product.

16. The method of claim 15 wherein the opportunity to halt future automated periodic shipments of the identified product comprises at least one of:
an opportunity to only-temporarily halt future automated periodic shipments of the identified product; and
opportunity to non-temporarily halt future automated periodic shipments of the identified product.

17. The method of claim 13 further comprising:
providing the particular customer with an opportunity to indicate at least one reason for returning the identified product; and
using the at least one reason to update the plurality of partiality vectors for the particular customer.

18. The method of claim 7 further comprising:
providing the particular customer with an opportunity to halt future automated periodic shipments of the identified product.

19. The method of claim 18 further comprising:
updating the plurality of partiality vectors for the particular customer in response to the particular customer halting future automated periodic shipments of the identified product.
